(19) United States
(12) Patent Application Publication
(10) Pub. No.: US 2005/0075125 A1
(43) Pub. Date: Apr. 7, 2005

(54) Method and mobile station to perform the initial cell search in time slotted systems

(76) Inventors: Anna Marina Bada, Milano (IT); Chiara Cavaliere, Rho (IT)

Correspondence Address: BIRCH STEWART KOLASCH & BIRCH, PO BOX 747, FALLS CHURCH, VA, 22040-0747, US

(21) Appl. No.: 10/498,521

(22) PCT Filed: Jan. 21, 2002
(86) PCT No.: PCT/IT02/00035

(51) Int. Cl. H04Q 7/20

(52) U.S. Cl. 455/525

(57) ABSTRACT

A method is disclosed that a Mobile Station MS performs at switch-on to search the most favorable target cell in UMTS systems like the 3GPP CDMA—LCR (Low Chip Rate) option at 1.28 Mcps—TDD (Time Division Duplex) mode and the equivalent TD-SCDMA (Time Division—Synchronous CDMA). Signal at the MS antenna is the sum of different RF downlink frames coming from different carriers in the assigned frequency ranges. A DL synchronization timeslot and a BCCH TS0 are both transmitted with full power in the frames, the first one includes one out of 32 SYNC codes assigned on cell basis. Following a conventional approach the absence of a common downlink pilot and without prior knowledge of the used frequencies would force the MS, for all the frequencies of the channel raster stored in the SIM card, the correlation of the received frame with all the 32 SYNCs stored in the MS, in order to detect the BSIC of a cell to which associate the power measures. Following the two-step method of the invention the power measures are performed in two-step scan of the PLMN band without interleaved correlation steps; once a final frequency is selected the respective frame is the only correlated one. At least one frame duration about 5 ms long of the whole 15 MHz bandwidth is acquired, IF converted, A/D converted and the digital set is stored. A rough scan is performed multiplying the digital set by a digital IF tuned in steps wide as the channel band (1.6 MHz) along the 15 MHz band, and filtering the baseband signal with a Root Raise Cosine low-pass filter. The 5 ms baseband signal is subdivided into 15 blocks of half timeslot (337.5 μs) and the power of each block is measured. The power of the strongest block indicates the priority of the respective frequency. The strongest power values are put in a Spectral Table together with respective frame load indicators. The load indicator is the percentage of timeslots in a frame almost equally loaded as the strongest block. The three strongest frequencies are selected for the successive scan. The second step search is performed like the first one but the IF steps are now 200 kHz wide and cover the only 1.6 MHz spectrum around a selected frequency. A final frequency is selected for the successive correlation step. Then the frequency error of the MS reference oscillator is corrected with data-aided techniques and a calibration value stored for successive connections (FIG. 9).

### FIELD OF THE INVENTION

The present invention relates to the field of radiomobile systems and more precisely to a method to perform the initial cell search in time slotted systems and Mobile Station (MS) architecture.

### BACKGROUND ART

Initial cell search is executed by the MS at switch-on time for the purpose of finding a cell from which the downlink data can be reliably decoded and that has high probability of communications on the uplink. Due to the next marketing of the new 3-th generation PLMNs (Public Land Mobile Network), which for a certain time add up their features to the existing PLMNs the initial cell search will be a very problematic task for the MS (Mobile Station) because of the presence of a lot of operating bands and different synchronization requirements.

FIG. 1 schematizes a possible typical radiofrequency simplified scenario a Mobile Station MS1 is faced with. The depicted scenario includes three cells: Cell 1 in which the MS1 is located and two adjacent cells Cell 2 and Cell 3. A possible disturbing MS2 is located in Cell 3. The cells are served by respective BTSs (Base Transceiver Station) in corner-excited configuration (BTS1 and BTS2 are the only visible). Two different PLMN systems, namely PLMN1 and PLMN2, share the same BTSs. The signal at the MS1 antenna is the sum of different RF frames coming from different carriers pertaining the two systems. PLMN1 is one of the 3GPP (3-rd Generation Partnership Project) UMTS (Universal Mobile Telecommunication System) systems based on CDMA (Code Division Multiple Access) technique. Relevant 3GPP documents are the ones specifying an UTRA (Universal Terrestrial Radio Access) interface for the User Equipment (UE). UTRA's standardization establishes the minimum RF characteristics of the FDD (Frequency Division Duplex) and TDD (Time Division Duplex) mode. The FDD mode at 3.84 Mcps (Mega-chips-per-second) is known as W-CDMA (Wideband), while the TDD mode includes an HCR (High Chip Rate) option at 3.84 Mcps and a LCR (Low Chip Rate) option at 1.28 Mcps. Mostly features of the 1.28 Mcps standard has been jointly developed by the present Applicant and the CWTS (Chinese Wireless Telecommunication Standards) partner. The resulting system known as TD-SCDMA (Time Division—Synchronous CDMA) Radio Transmission Technology (RTT) has been proposed to the 3GPP by CWTS committee, it adopts the same physical layers as UTRA-LCR-TDD, differing from the last mainly because of the synchronization of the BTS between adjacent cells. PLMN2 could be one of the following PLMNs: GSM 900 MHz (Global System for Mobile communications), DCS 1800 MHz (Digital Cellular System) similar to the preceding one, GPRS (General Packet Radio Service) and EGPRS (Enhanced GPRS) added to the GSM for enabling it to manage packet data. In the PLMN2 f_{BEAC1} and f_{BEAC2} are two beacon carriers broadcasted by BTS1 and BTS2 respectively. Each beacon carrier is accompanied by the subset of GSM carriers used in that cell in the observance of the known cluster's rule for the frequency assignment. In the PLMN1 three CDMA carriers per cell are considered without limitation. The GSM's cluster rules are not mandatory for PLMN1 which, differently from PLMN2, may use the same or different frequencies in adjacent cells, depending on the traffic planning. In the following part of the description MS and UE are synonyms so as BTS and BS (Base Station).

The national telecommunications Authorities usually assign the frequency bands to the various PLMNs in order to avoid overlap and reciprocal interferences. TABLES 1 to 4 of APPENDIX A include all the standardized frequency bands for the aforementioned PLMNs. The initial cell search results in a list of acceptable cells of the selected PLMN (by hypothesis PLMN1 of FIG. 1) sorted by decreasing priority. If the list is not empty the MS chooses the cell of highest priority for indicating its presence to the network and access to the services. Because of the different architectures of the radio interface among the different standards, the initial cell search performed by the MS takes some peculiarities of the selected PLMN, despite the general criteria of filling in the priority list by decreasing power either of the received beacon carriers (GSM) or the beacon channels (CDMA). Power measures for initial cell search are generally performed by an MS which has not prior knowledge of which carriers the system actually uses for broadcasting the system information, so it shall search all RF channels within the band of operation of each selected PLMN. In order to speed up the search the MS can optionally store into the SIM card (Subscriber Identity Module), which is a non-volatile memory enabling the MS operation, a list of carriers used by the PLMN selected when it was last active (the carriers used are a subset of the permissible carriers). For the sake of completeness, an MS already camped on a cell repeatedly executes the cell selection and reselection procedure which take the place of the initial cell search.

In order to properly set the technical problem solved by the present invention a glance to the different physical layers and the involved cell search procedures are needed. FIGS. 2a and 2b concern GSM, FIG. 3 concerns UTRA-FDD, FIG. 4 concerns UTRA-TDD at 3.84 Mcps, and FIG. 5 concerns both UTRA-TDD at 1.28 Mcps and TD-SCDMA. While GSM is based on both FDMA (Frequency Division Multiple Access) and TDMA (Time Division Multiple Access) techniques, the UTRA systems add up CDMA which is quite a different approach to perform multiple access. As known, CDMA is obtained by summing up in baseband K bit-streams coming from K1 users, each of them being obtained multiplying (modulating) each oversampled bit of the original signal by a K2-th spread sequence taken from an orthogonal set of K (being K1≦K2 and K2≦K so that a single user can handle more than one code): the so-called OVSF (Orthogonal Variable Spreading Factor codes). The original channel band resulting by said modulation is enlarged and the information is spread in the wider CDMA channel band. CDMA forces a different system philosophy for discriminating among the various cells, because, differently from GSM, adjacent CDMA cells may use the same frequencies. Various pilot sequences associated with midambles and scrambling code groups assigned on cell basis are used in the system for discriminating between adjacent cells. Cyclic shifts of the midambles and marked synchronization sequences are further used for more detailed discrimination inside a service cell. In FIG. 2a a possible GSM signalling multiframe for medium/small BTSs (Base Transceiver Station) is shown. The signalling multiframe includes 51 basic frames as the one 4.615 ms long shown in FIG. 2b. Letters F, S, B, and C indicate, in the order, the following control channels carried by timeslot 0 of a relevant beacon F0: FCCH (Frequency Correction CHannel), SCH (Synchronization CHannel), BCCH (Broadcast Control CHannel), and CCCH (Common Control CHannel). The physical bursts of FCCH and SCH downlink channels are depicted in FIG. 2b. FCCH burst includes 142 useful bits at logic level “one” in order to allow the correction of the clock frequency of the MS oscillator when this burst is received (and easily recognized). The SCH burst includes a 64 bit “Synchronization Sequence” in midamble position and 2×39 Encrypted bits. The SCH burst is always received by the MS with an 8 time slot delay (45.6 ms) from the FCCH burst, therefore the Mobile that has already corrected the frequency of its own clock can discriminate with the due precision the correct position of the Synchronization Sequence within the received burst, and then the starting instant of the time slot and the frame. Delay of 45.6 ms is reasonably short, in line with the synchronization requirements of a GSM Mobile having access for the first time to the network, or remaining in Idle state. The Encrypted bits contain the information necessary to reconstruct the Frame Number FN for completing the synchronization procedure, and a BSIC field (Base Station Identity Code) useful to the Mobile to identify the BCCH carrier (beacon) of the serving cell from the BCCH carriers of the adjacent cells. The BCCH channel is used to diffuse downlink general use system information, such as for instance: the configuration of channels within the cell, the list of BCCH carriers of the adjacent cells on which performing the level measurement, the identity of the Location Area and some parameters for the Cell Selection and Reselection activity, the complete Cell Identity, parameters for the operation of the MS in Idle Mode and parameters for Random Access. The CCCH bi-directional channel includes three subchannels: a first AGCH (Access Grant CHannel) and a second PCH (Paging CHannel) in downlink, and third RACH (Random Access CHannel) one shared in uplink. As far as concerns the measures for initial cell search, the MS starts searching for the FCCH channel, if this channel is found the scanned frequency is a beacon frequency otherwise a frequency N+1 is scanned. When the FCCH channel is detected the outlined frequency and frame synchronization mechanism put into action by the two FCCH and SCH channels detects the beginning of time slot T0 and the frame. Power measurements on the FCCH, SCH, and BCCH channel are possible consequently. These channels are continuously transmitted at full power from the BTSs just for the purposes of cell search, cell selection and reselection, and handover. Power measurements relevant to each beacon frequency enter the priority list. The selected cell is the one of whose BSIC is associated to the top carrier on priority list.

In FIG. 3 a basic radio synchronization frame of 3GPP UTRA-FDD (W-CDMA) is shown (see 3GPP TS 25.211, Version 4.2.0 (2001-09) Release 4). The downlink frame is 10 ms long and includes 38,400 chips belonging to 15 timeslots TS0 . . . TS14, each of 2560 chips. The first 256 chips of each timeslot are assigned to a downlink Synchronization Channel SCH used for cell search. The SCH channel consists of two subchannels, the Primary and Secondary SCH, whose digital patterns are not orthogonal with the other spread channels and can be distinguished from them even in a noisy environment. The primary SCH consists of a modulated code of 256 chips, named Primary Synchronization Code (PSC), which is the same for every cell in the system. The secondary SCH consists of a modulated code of 256 chips, named Secondary Synchronization Code (SSC), transmitted in parallel with the Primary PSC. The SSC code is denoted cₛ^{i,k}, where i=0, 1, . . . , 63 is the number of the scrambling code group, and k=0, 1, . . . , 14 is the timeslot number. Each SSC code is chosen from a set of 16 different codes of length 256. This sequence on the Secondary SCH indicates which of the code groups the cell's downlink scrambling code belongs to. Other important downlink control channels are the Primary Common Pilot Channel (P-CPICH) and the Primary Common Control Physical Channel (P-CCPCH). The P-CPICH channel has the following characteristics: there is one and only one P-CPICH per cell; it is broadcasted over the entire cell and is scrambled by the primary scrambling code assigned on cell basis. The P-CPICH channel is used to discriminate the scrambling code group of a cell. The P-CCPCH channel is a fixed rate physical channels (30 kbps, SF=256) used to carry the BCH transport channel. SCH, P-CPICH, and P-CCPCH channels are continuously transmitted at full-power in the whole cell for initial cell search, cell selection and reselection, handover, and the reading of the system information. As far as cell search concerns (see 3GPP TS 25.214, Version 4.2.0, 2001-09, Release 4) for each scanned frequency the cell search is typically carried out in three steps:
Step 1. Slot synchronization: During the first step the UE uses the SCH's primary synchronization code to acquire slot synchronization to a cell. This is typically done with a single matched filter (or any similar device) matched to the PSC code which is common to all the cells. The slot timing of the cell can be obtained by detecting peaks in the matched filter output. The frequency of the UE's reference oscillator can be adjusted in the meanwhile to meet the specifications.
Step 2. Frame synchronization and code-group identification: During the second step the UE uses the SCH's secondary synchronization code to find frame synchronization and identify the code group of the cell found in the first step. This is done by correlating the received signal with all possible SSC sequences, and identifying the maximum correlation value. Since the cyclic shifts of the sequences are unique the code group as well as the frame synchronization is determined.
Step 3. Scrambling-code identification: During the third and last step the UE determines the exact primary scrambling code used by the found cell. The primary scrambling code is typically identified through symbol-by-symbol correlation over the CPICH with all code group identified in the second step. After the primary scrambling code has been identified, the Primary CCPCH can be detected and the system and cell specific BCH information can be read. If the UE has received information about which scrambling codes to search for, steps 2 and 3 above can be simplified.

Power measurements relevant to each scanned frequency enter the priority list. The selected cell is the one whose Primary Scrambling Code is associated to the top carrier on priority list. Power measurements can be usefully performed on the SCH, P-CPICH, and P-CCPCH channels. At the initial cell search the measure of the received power in correspondence of the only Primary SCH channel could speed-up the whole frequency scan.

In FIG. 4 a basic radio synchronization frame of 3GPP UTRA-TDD for 3.84 Mcps is shown (3GPP TS 25.221, Version 4.2.0 (2001-09) Release 4). The frame is 10 ms long and includes 38,400 chips belonging to 15 timeslots TS0 . . . TS14, each of 2560 chips. The purposes of the SCH channel are near the same as UTRA-FDD of FIG. 3. SCH frame includes one or two SCH timeslots 8 positions spaced apart (i.e. TS0 and TS8). One Primary and three Secondary SCH are in parallel. Primary and Secondary SCH have a delay t_{offset} from the beginning of the timeslot. A Primary Common Control Physical Channel (P-CCPCH) is located in a position (time slot/code) known from the Physical Synchronization Channel (PSCH). The Broadcast Channel (BCH) is a downlink common transport channel mapped onto the P-CCPCH channel to broadcast system and cell-specific information. For the purpose of measurements, physical channels at particular locations (timeslot, code) shall have particular physical characteristics, called beacon characteristics. Physical channels with beacon characteristics are called beacon channels and are located in beacon locations. The beacon locations are determined by the SCH channel. The ensemble of beacon channels shall provide the beacon function, i.e. a reference power level at the beacon locations. Thus beacon channels must be present in each radio frame. Note that by this definition the P-CCPCH always has beacon characteristics. As far as cell search concerns, for each scanned frequency the initial cell search is typically carried out in three steps similar to the ones valid for the preceding UTRA-FDD case, and also the top-list cell selection criterion is the same.

In FIG. 5 a basic TD-SCDMA radio frame is depicted. The basic frame (see 3GPP TS 25.221, Version 4.2.0 (2001-09) Release 4) has a duration of 10 ms and is divided into 2 subframes of 5 ms. The frame structure for each subframe in the 10 ms frame length is the same. A multiframe is a module N number of frames. Each 5 ms subframe has 6,400 chips (T_{c}=0.78125 μs) subdivided into 7 timeslots for data (TS0, . . . TS6) of 864 chips, plus three special timeslots named DwPTS (Downlink Pilot Time Slot), GP (Main Guard Period), and UpPTS (Uplink Pilot Time Slot). TS-SCDMA can operate on both symmetric and asymmetric mode by properly configuring the number of downlink and uplink time slots and the switching point consequently. In any configuration at least one time slot (time slot#0) has to be allocated for the downlink and at least one time slot has to be allocated for the uplink (time slot#1). The burst of data at the bottom left of the Figure includes a central midamble and two identical data parts. The data parts are spread with a combination of channelisation code (OVSF 1, 2, 4, 8, or 16) and scrambling code. The scrambling code and the basic midamble code are constant within a cell. The K1 simultaneous users which share an uplink timeslot are distinguishable each other at the BTS side by K1 shifted versions of the basic midamble code. The DwPTS burst at the bottom right of the Figure includes a Guard Period GP and a 64-chips SYNC sequence used for downlink frame synchronization. FIG. 6 schematizes the TD-SCDMA criterion to share among different cells the 32 available SYNC sequences characterizing the DwPTS pilot, the 32 associated scrambling code groups, the midamble associations with the code groups, and the K=16 midamble shifts. From the diagram of FIG. 6 it can be argued that since the SYNC and the basic midamble code groups are related one-to-one, the UE knows which 4 basic midamble codes are used. Then the UE can determine the actually used basic midamble code using a try and error technique. The same basic midamble code will be used throughout the frame. As each basic midamble code is associated with a scrambling code, the scrambling code is also known by that time.

Primary Common Control Physical Channel (P-CCPCH1 and P-CCPCH2) is fixedly mapped onto the first two code channels of timeslot TS0 with fixed spreading factor of 16. The P-CCPCH channel is a beacon channel (like DwPTS) always transmitted with an antenna pattern configuration that provides whole cell coverage. The Broadcast Channel (BCH) is a downlink common transport channel mapped onto the P-CCPCH1 and P-CCPCH2 channels to broadcast system and cell-specific information. The BCH is transmitted in TS0 always with the midamble code obtained by the first time shift from the base midamble code. The location of the interleaved BCH blocks in the control multi-frame is indicated by the QPSK [Quadrature Phase Shift Keying] modulation of the DwPTS pilot with respect to midamble code. As far as initial cell search concerns the 3GPP specifications (TS 25.224, Version 4.2.0, 2001-09, Release 4) say that is typically carried out in four steps:
Step 1. Search for DwPTS—During the first step of the initial cell search procedure, the UE uses the SYNC (in DwPTS) to acquire DwPTS synchronization to a cell. This is typically done with one or more matched filters (or any similar device) matched to the received SYNC-DL which is chosen from PN sequences set. A single or more matched filter (or any similar device) is used for this purpose. During this procedure, the UE needs to identify which of the 32 possible SYNC sequences is used. The frequency of the UE's reference oscillator can be adjusted in the meanwhile to meet the specifications (0.1 ppm).
Step 2. Scrambling and basic midamble code identification—During the second step of the initial cell search procedure, the UE determines the midamble for the k-th burst of data and the associated scrambling code. According to the result of the search for the right midamble code, UE may go to next step or go back to step 1.
Step 3. Control multi-frame synchronization—During the third step of the initial cell search procedure, the UE searches for the MIB (Master Indication Block) of multi-frame of the BCH. According to the result UE may go to next step or go back to step 2.
Step 4. Read the BCH—The (complete) broadcast information of the found cell in one or several BCHs is read. According to the result the UE may move back to previous steps or the initial cell search is finished.

The wide presentation of the prior art includes the most digital PLMNs known up till now. Third generation cellular systems other than 3GPP have features widely referable to that standardization.

Outlined Technical Problem

A sound procedure for the initial cell search shall take into account the worst case in which the mobile station at switch-on has not prior knowledge of which carriers the system actually uses for broadcasting the system information, so it shall scan all the permitted carriers within the band of operation of the selected PLMN. The sound procedure must give a reliable information about the pathloss of a scanned carrier, so that the priority list can be a useful tool. The mobile station shall therefore carry out power measures in correspondence of at least one beacon channel, that should be necessarily detected in the meanwhile. The detection of a beacon channel means also detecting all the relevant physical entities building the beacon channel up in conformity with the selected PLMN. A first physical entity to consider is the frequency; a second one is the temporal subdivision of the baseband digital signal into discrete time intervals (bursts, timeslots, subframes, frames, multiframes, etc.); a third entity is the digital pattern transmitted in the beacon burst. The physical entities differently characterize the beacon channels used in the highlighted PLMN of the prior art. It's useful to remind that:
GSM makes use of FCCH and SCH frequency and time synchronization patterns common to the whole system. Besides the SCH channel includes the BSIC for identifying the cell transmitting the received FCCH and SCH beacons.
3GPP UTRA-FDD and 3GPP UTRA-TDD 3.84 Mcps option make use in downlink of a Primary SCH subchannel common to the whole system for obtaining timeslot synchronization, and secondary SCH and CPICH channels to obtain cell-based scrambling code group and single scrambling code.
3GPP UTRA-TDD 1.28 Mcps option, or TD-SCDMA, makes use of 32 DwPTS downlink synchronization sequences which are known by all the cells. One out 32 DwPTS sequence is assigned to the single cell in order to obtain the respective scrambling code group and the single scrambling code.

The procedure for initial cell search should consist of as many scanning steps as the permitted carriers. Each scanning step includes the selection of a carrier, the detection of a beacon channel which conveys suitable cell information, the execution of a power measurement in the channel band at the occurrence of the beacon channel. The scanning raster is 200 kHz for all the above PLMNs. The channel band is quite different: 200 kHz for GSM; 5 MHz for 3GPP UTRA-FDD and 3GPP UTRA-TDD 3.84 Mcps option; 1.6 MHz for 3GPP UTRA-TDD 1.28 Mcps option and TD-SCDMA. While the selection of a carrier is immediate, the detection of a beacon sequence takes the time to calculate the correlation between the received sequence and the known beacon pattern (or patterns). More in particular:
In case of GSM the search for a beacon channel is considerably sped up by the FCCH channel which points to the SCH channel 8-timeslots later. The detection of FCCH is very fast. The correlation with SCH is simplified from the short correlation window descending from the preceding FCCH detection. The detection of an SCH pattern allows frame synchronization and consequent power measurement of the BCCH channel in correspondence of timeslot TO of the next BCCH's frames. The initial cell search is fast and easy in GSM system.
In case of 3GPP UTRA-FDD and 3GPP UTRA-TDD 3.84 Mcps option the detection of primary SCH is more expensive than GSM due to the longer primary code (256 chips in comparison with 64 bits) and the absence of a Frequency Correction Channel pointing to the SCH channel directly. Despite this complication the SCH detection can be completed in reasonably short time thanks to the singleness of the SCH patterns in the whole system, which needs a correlation only, jointly with the occurrence of the SCH sequence at each timeslot (2560 chips). Once timeslot synchronization is reached the other steps leading to the acquisition of CPIC and CCPCH beacons of the specific cell are considerably simplified due to the short correlation window. Power measurements on CPIC and CCPCH for entering the priority list are consequent. It can be conclude that the initial cell search is only moderately expensive in respect of GSM.
In case of 3GPP UTRA-TDD at 1.28 Mcps and TD-SCDMA systems, for each frequency of the Initial cell search procedure, the only step “Search for DwPTS” requests the UE to correlate the whole 6400 chips of the frame with each one of the 32 SYNCs sequences 64 chips long. This formidable task (N-frequencies×32 of such long correlations) largely outperforms the calculation power of the UE making de-facto impossible a reasonably fast cell search.

### OBJECTS OF THE INVENTION

The main object of the present invention is that to indicate an initial cell search method able to overcome the drawbacks encountered in TD-SCDMA and all similar systems.

Other object of the invention is that to indicate a procedure that is able to correct the frequency error once a target carrier has been selected.

Further objects of the invention is that to indicate a Mobile station able to perform the claimed method.

### SUMMARY AND ADVANTAGES OF THE INVENTION

To achieve said objects the present invention suggests a method for initial cell searching, as disclosed in the method claims. Further subject of the invention is a Mobile station which performs the claimed method, as disclosed in the device claims.

As disclosed in the claims, the method of the invention completes the frequency scan in the band of interest before passing to the correlation step for the detection of a cell. In that the frequency scan is performed continuously without introducing correlation steps, but exploiting the only spectral information originated from the transmitted power. This seems novel in respect of the cellular systems of the prior art where the steps of the frequency scan are interleaved with step of correlation with a pilot channel common in the whole system (like the FCCH and SCH bursts of the GSM, or the P-SCH burst used in both W-CDMA and UTRA-TDD-HCR). No mention of an initial frequency scan procedure like the one of the invention is treated in the specifications. The disclosed technical feature is useful in those systems in which a common Pilot is not foresee to synchronize the mobile station downlink, but the only synchronization tool is a set of synchronization sequences associated with the cells one-to-one. The advantage of the proposed method is that do not interleave a cumbersome correlation at each frequency step. Besides, the two-step frequency scan, firstly rough and then fine, considerably speed up the scan operation because an only subset of all the permissible frequencies is examined. The generality of the method covers systems other than TDD and it can be easily arranged even for those systems in which a common pilot exists, in this eventuality the initial cell search could be sped up by completing the two-step frequency scan, firstly, and then perform correlation between the only digital set of the final selected frequency and the synchronization burst SCH common to the whole system. In the GSM case this way of operations leads to the BSIC and the BCCH channel with a single correlation step, while in case of W-CDMA and UTRA-TDD-HCR successive correlation steps with all the possible Secondary SCH (16) are needed. In both the case the overall number of correlations is much lower than the conventional approach. A big deal of innovation of the present invention is the analysis of the shape of the power evaluated over a certain time duration of the signal (typically a frame), necessary because of the absence of a continuously pilot channel in the system.

As far as the power measurement concerns, a baseband frame (5 ms) is stored at each frequency step. The stored signal is subdivided in blocks spanning half timeslot duration and the power of each block is calculated. Blocks as wide as half timeslot constitute an optimal choice for TD-SCDMA systems in which P-CCPCH and Dw-PTS occupy two adjacent timeslots, the length could be reasonably varied to meet other PLMNs. The resulting shape of the power envelope reflects a trade-off between the need to give a realistic representation of the fading and that to save the unitary concept of timeslot, so the envelope along a timeslot shouldn't vary too much. A final criterion valid for PLMNs other than TD-SCDMA should be that to have blocks long at least half the duration of a synchronization sequence, because the last is usually shorter than a service burst. This criterion maximizes the peak of the calculated power envelope.

According to the invention, for each scanned carrier the power of the strongest block in the frame is stored in a spectral table of the MS and those carriers associated to the strongest blocks are selected at the rough scan. The same criterion is used for the selection of the final carrier with fine scan. This criterion is simple and reliable in almost all the real conditions. Suppose an MS located in a first cell and an adjacent cell is transmitting on the same frequency (the considered system is CDMA-TDD), the MS always measures in correspondence of the common frequency a power which is the summation of the signals received from both the cells, this is true for all the timeslots. The common carrier enters the spectral table of the MS with the power of the strongest block as it results from the contributions of the two cells. The summation of the powers received from the two cells increases the probability that the common frequency be selected. Even in this circumstance the successive correlation step discriminates between the SYNC code of the two cells thanks to the good autocorrelation property of said codes and their poor cross-correlations. Downlink synchronization of adjacent cells is not a strictly mandatory requirement for the method of the invention, nonetheless it is a feature particularly useful in TDD systems, especially for those Mobile Stations located midway two cells. In this context the frame synchronization allows to perform more realistic selection, as will be cleared up later on.

The method of the invention additionally introduces the “load” of a frame as a new indicator suitable for the initial cell search. The frame load indicator is calculated from the shape of the power envelope along the considered frame, it corresponds to the percentage of timeslots over a calculated power threshold. Frame load indicators have been advantageously included in the spectral table near the respective strongest blocks (see % Busy of FIG. 12). Under certain hypotheses this indicator gives an idea of how many timeslots in a frame are busy, for example because engaged in traffic operations. “Unloaded” frames have higher probability to include free timeslots than “loaded” frames. In case two carriers have almost the same power of the respective strongest blocks, the selection of the carrier with lower load indicator will increase, on average, the successfully attempts in call set up. It's useful point out that the aforementioned selection criterion based on the strongest block allows a frame with low load to be chosen, because at least one timeslot (DwPTS, TS0) is always transmitted with maximum or nearly maximum power. A condition for a reliable frame load indicator is the poor influences of the neighbor cells, as it certainly happens indoor or when the MS is far from the cell boundary. Inside isolated or nearly isolated cells the frames with equal load indicators also include the same number of busy blocks, otherwise the busy indication is misleading because a block can surpass the power threshold to be considered busy thanks to the significant contributes of the neighbour cells.

For radio access systems based on Time Division Duplex (TDD) mode, like the TD-SCDMA, the frame timing synchronization is an important feature to minimize interferences and optimize the offered traffic capacity. Frame timing synchronization may imply: slot, frame, multi-frame or hyper-frame synchronization within BTSs of the network. Time slot synchronization avoids a disturbing radio link on a time slot to affect radio links on two time slots in a neighbouring cell. Frame synchronization ensures that uplink and downlink transmission directions are positioned, at least for adjacent cells, at the same instant; this prevents a receiving mobile (MS1 of FIG. 1) to be saturated by near transmitting mobiles (MS2 of FIG. 1) camping in a neighbouring cell (cell 3). Control multi-frame synchronization ensures that the same type of logical channel (e.g. PCH, BCCH, . . . ) is broadcast by adjacent cells at the same time-frame; this allows to speed up the cell re-selection process in the MSs, without discontinuity in detecting the relevant system information. Frame timing synchronization can be achieved in different ways or combinations, i.e.: sending the synchronization pulses via cable; equipping the BTSs with a GPS (Global Positioning System) receiver for detecting the time reference signal; and finally using a radio channel to synchronize over the air the base stations to each other, as disclosed in the international patent application WO 01/17137 filed on 24-07-2000 in the name of the same Applicant.

### BRIEF DESCRIPTION OF THE DRAWINGS

The features of the present invention which are considered to be novel are set forth with particularity in the appended claims. The invention, together with further objects and advantages thereof, may be understood with reference to the following detailed description of an embodiment thereof taken in conjunction with the accompanying drawings given for purely non-limiting explanatory purposes and wherein:

FIG. 1 shows a possible scenario in which a Mobile Station of the present invention receives radiofrequency signals transmitted by two adjacent cells sharing two distinct PLMNs;

FIG. 2a shows a possible GSM signalling multiframe for medium/small BTSs;

FIG. 2b shows a GSM basic signalling frame and the FCCH and SCH bursts alternatively transmitted on timeslot TS0;

FIG. 3 shows an UTRA-FDD basic synchronization frame and the structure of the Synchronization Channel SCH;

FIG. 4 shows an UTRA-TDD-HCR basic synchronization frame and the structure of the Synchronization Channel SCH;

FIG. 5 shows a TD-SCDMA basic frame, the burst structure of a generic timeslot for data, and the burst structure of the DwPTS timeslot;

FIG. 6 schematizes a TD-SCDMA criterion to share among different cells the different DwPTS's synchronization sequences, scrambling codes, and midambles;

FIG. 7 shows a simplified block diagram of a kind of Base Station Transmitter of the known art;

FIG. 8 shows a block diagram of an MS receiver suitable for implementing the method of the present invention;

FIG. 9 gives an outline of the initial cell search method of the invention;

FIGS. 10a and 10b show two power profiles vs frequency scan with two different frequency step: one is equal to the channel bandwidth and the other is equal to half of the channel bandwidth;

FIG. 11 shows a possible power envelope along a frame of the received signal, as measured by the MS at each frequency step;

FIG. 12 shows a spectral table used in the method of the invention;

FIGS. 13a, 13b, and 13c show different types of frequency errors before and after calibration and during normal operation, as they result at the end of the method of the invention.

APPENDIX A: TABLES 1A to 4A include all the standardized frequency bands for the most popular PLMNs;

APPENDIX B: TABLES 1B gives the number of iterations of the frequency scan method;

APPENDIX C: TABLES 1C to 7C include background on test environment and the results of simulations useful to test the method of the invention.

### DETAILED DESCRIPTION OF AN EMBODIMENT OF THE INVENTION

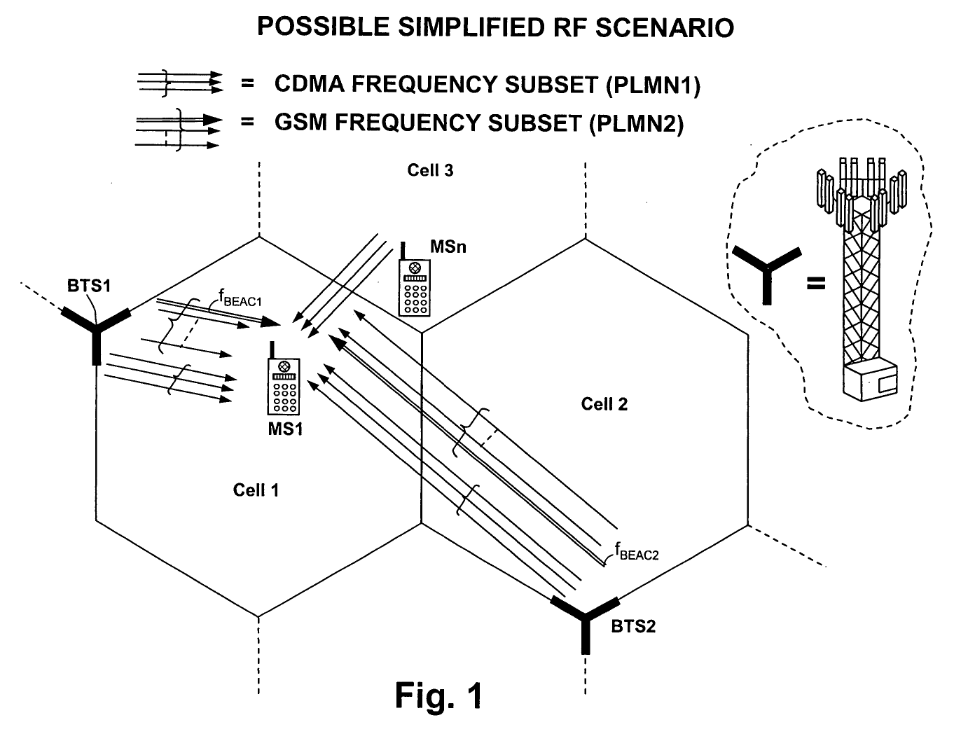

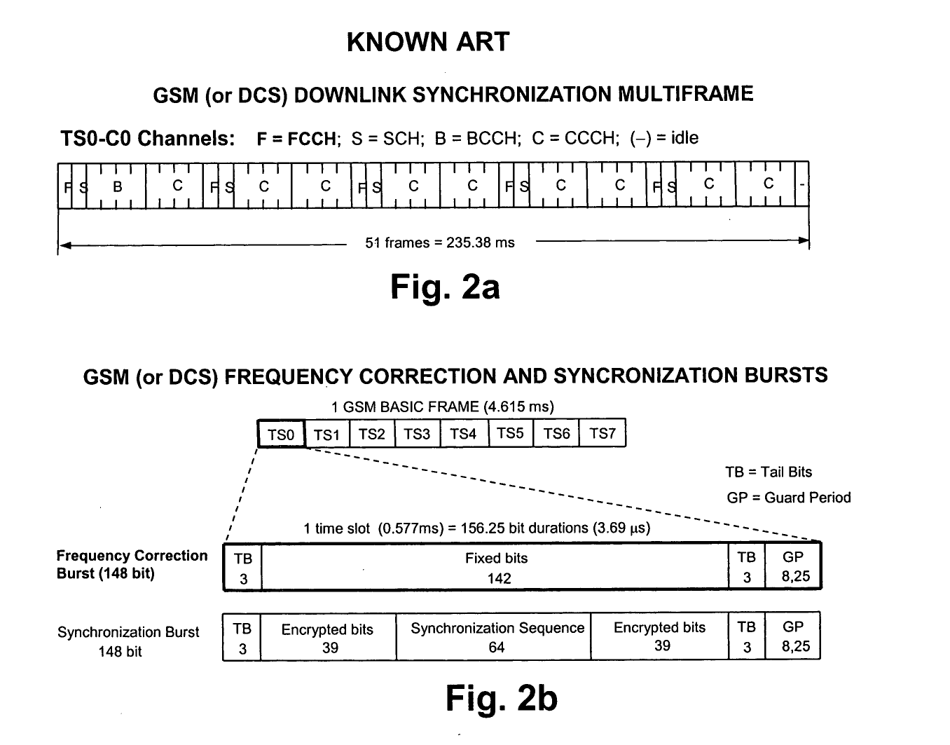

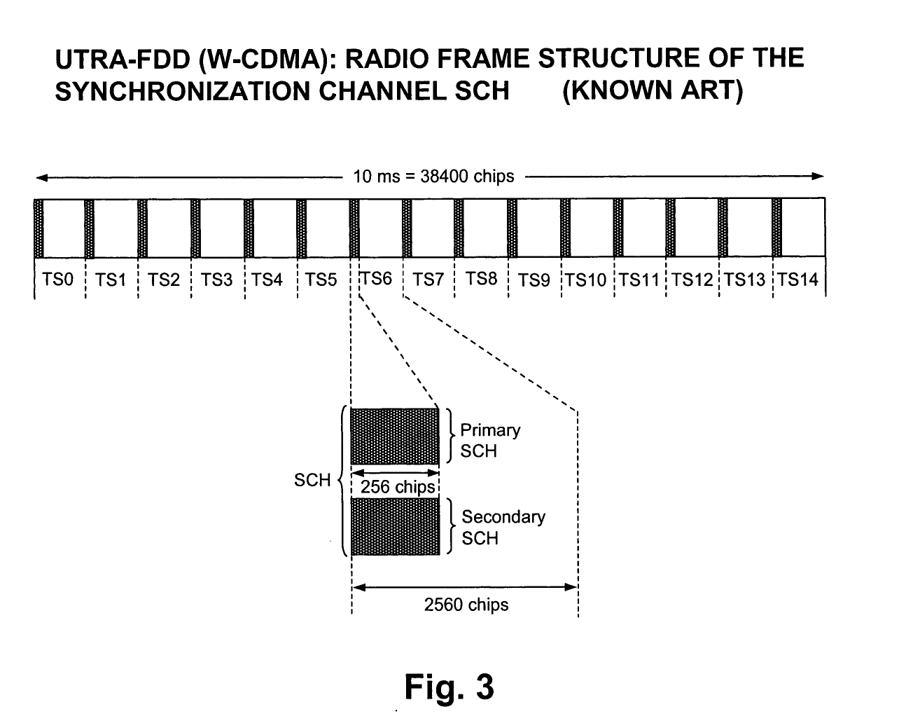

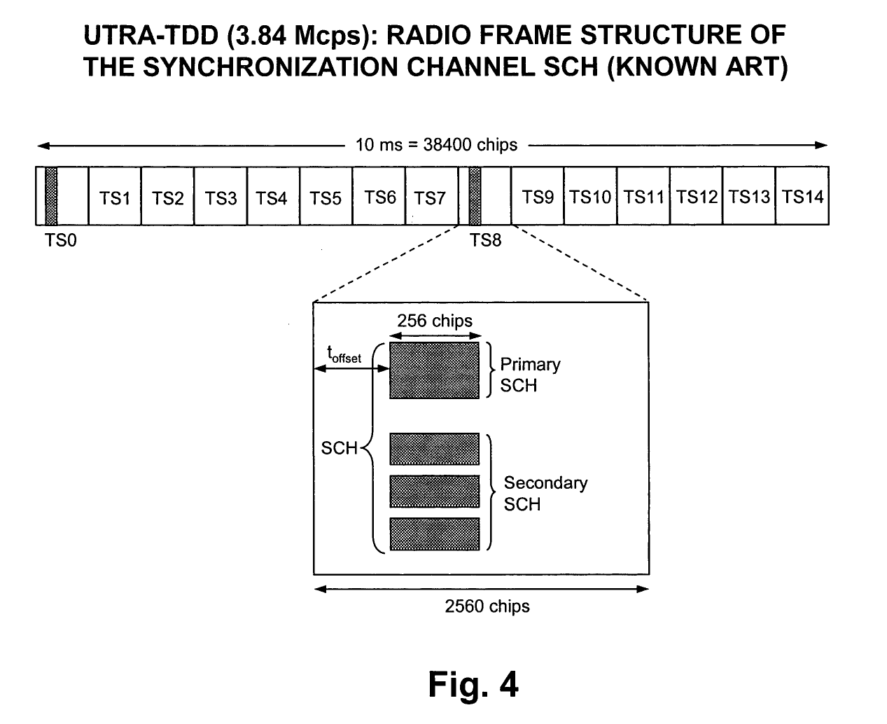

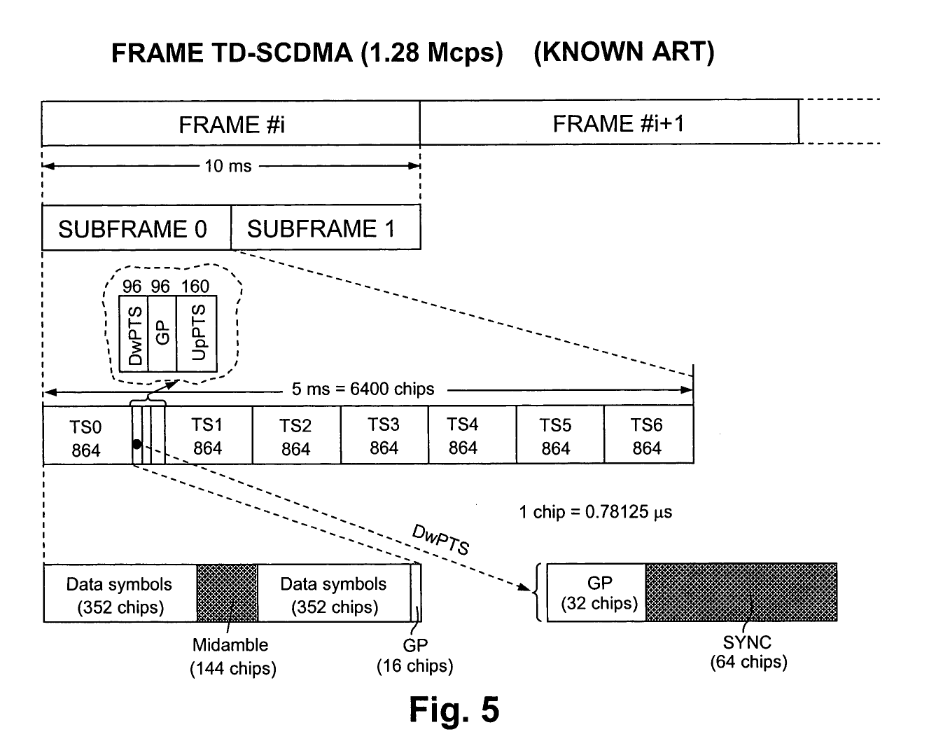

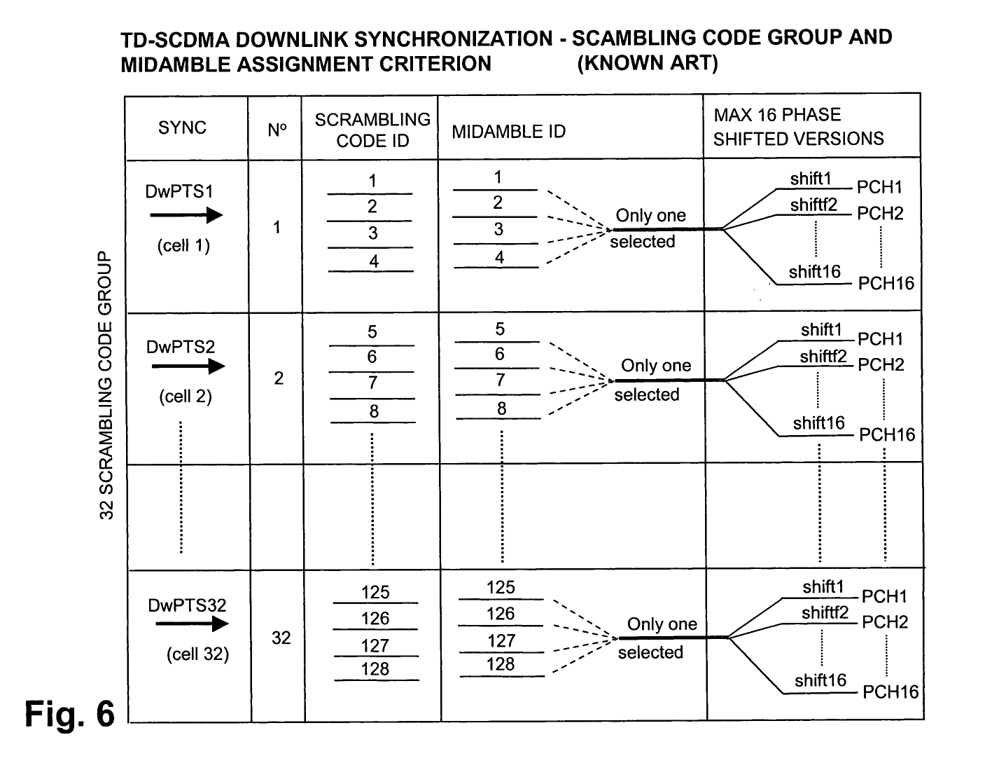

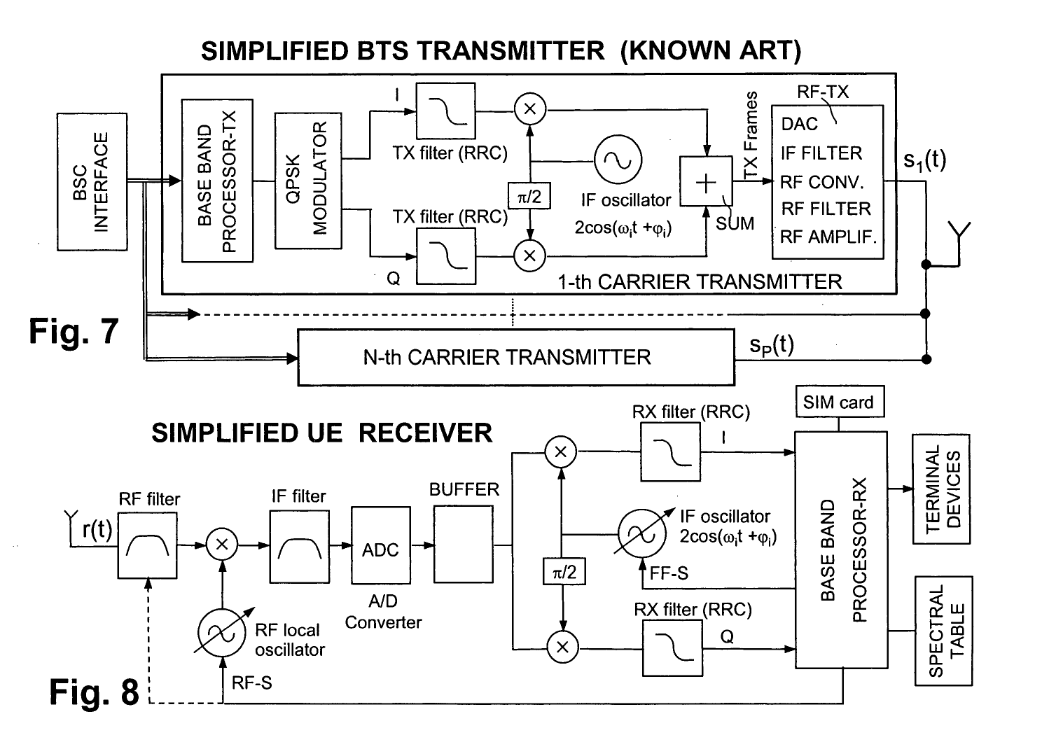

FIG. 1 to 6 have been already discussed. FIG. 7 schematizes without limitation a possible narrowband architecture of a BTS TRANSMITTER of the known art. The transmitter includes a BSC (Base Station Controller) INTERFACE which forwards relevant protocol messages to as many CARRIER TRANSMITTERS as the carries planned in the cell. Each CARRIER TRANSMITTER includes the following minimum blocks: BASEBAND PROCESSOR-TX, QPSK MODULATOR, two equal TX filters of RRC type (Root Raise Cosine) with the low-pass channel band (1.6 MHz), IF oscillator (digital), SUM, and RF-TX. The BASEBAND PROCESSOR-TX receives the protocol messages and processes them according to the specifications. In particular it generates Traffic and Control transmission frames and multiframes spread on K-channels according to the FIG. 5. The QPSK modulator generates In-phase and In-quadrature I, Q frames filtered by the two TX filters. The I, Q filtered frames are digitally converted to the Intermediate Frequency IF and summed up by the digital adder SUM. The resulting TX frames are submitted to the successive block RF-TX which carries out typical operations in view of transmission (specified in the block). The radiofrequency signal s₁(t) is a QPSK modulated carrier which transports the TX Frames in the microwave spectrum into a channel band 1,6 MHz wide. The final RF (Radio Frequency) signal includes all the modulated carriers s₁(t), . . . , s_{P}(t) spaced apart in the PLMN band.

FIG. 8 schematizes an UE receiver suitable to perform the method of initial cell search of the invention. The depicted architecture is widely general and could be also referred to an MS receiver of the second generation. The reception signal r(t) reaches a band-pass RF filter, then the filtered signal is down-converted to IF by means of an analog mixer piloted by a signal generated from a RF local oscillator. The analog IF signal is filtered by a band-pass IF filter and delivered to an Analog to Digital Converter ADC. At the output of the ADC block is connected a memory BUFFER dimensioned to store at least a set of about 5 ms of the digital signal, in accordance with the implemented hardware option. With both the hardware options the memory BUFFER can be dimensioned to store about 5 ms digital signa, the dimension of the memory depends also on the number of samples used to represent every single chip (oversampling). At the output of BUFFER block the digital signal is split into two parts sent at first inputs of two equal digital multipliers. Second multiplier inputs are piloted by two π/2 out of phase IF signals generated from a numerical IF oscillator. At the output of the multipliers In-phase and In-quadrature baseband components I, Q are generated. The two components are filtered by two equal low-pass RX filters of RRC type with 1.6 MHz bandwidth. This value corresponds to the channel band B of a RRC filter with roll-off α=0.22 and chip-rate of 1.28 Mcps: B=(Chip_rate×(1+a)). The I, Q filtered components are sent to a block named BASEBAND PROCESSOR-RX which includes a microprocessor, a relative RAM, the Input/Output devices, a ROM for storing the microprocessor firmware and the 32 SYNC sequences foreseen in the system. The BASEBAND PROCESSOR-RX is further connected with a SIM card, which stores the bands of interest and all the permitted carriers inside a band (the channel raster), and with a memory called “Spectral Table” used for cell search. A block named Terminal devices is indicated for completeness. The frequency scan is performed on the basis of two hardware options, depending on the architecture used, by opportunely varying control signals RF-S and/or FF-S directed to the RF and the IF local oscillators, respectively.

There are generally no constraint with the hardware architecture used for the UE, so that the following hardware options can be indifferently implemented:
1. Both the RF and IF filter are 15 MHz bandwidth and the whole band is converted at IF. The Analog to Digital converter ADC processes the whole band in respect of the Nyquist criterion which imposes a sampling frequency of at least 30 MHz. The single frame of 5 ms (or N frames in case of averaging by N) sampled at 30 Msample/s generates about 150 Ksamples that have to be stored in the BUFFER memory. The frequency scan is performed multiplying the stored digital set by a digital IF frequency variable in (rough or fine) steps in order to baseband convert, in turn, the frequencies to evaluate. In this case the RF-S signal is fixed and the FF-S signal variable step-by-step. The frequency conversion of digital signals is known in the art. More in particular a digital IF oscillator is advantageously carried out starting from a ROM which stores a set of N2 digital samples taken from a sinusoidal wave (a quarter period is enough), and reading 1 out of N sequential samples for generating frequencies multiple-N of the fundamental. The ensemble of N2 different samples permits the representation of a number of sinusoidal signals equal to the largest integer less than N2/2. Digital multiplication needs the two signals at the inputs of each digital multiplier be at the same rate.
2. Both the RF and IF filter are 1.6 MHz bandwidth or the RF filter is wideband and the IF filter is 1.6 MHz bandwidth. The scan is performed varying the frequency of the RF local oscillator in (rough or fine) steps in order to convert at IF the frequencies to evaluate (superheterodyne). In case the RF filter is 1.6 MHz bandwidth, the RF-S signal variable step-by-step is also sent to the RF filter in order to tune it on the selected frequency. The single frame of 5 ms (or N frames in case of averaging by N) stored in the BUFFER memory concerns the selected channel only. In this case the sampling frequency is at least 3.2 MHz and the BUFFER memory stores near 16 Ksamples. The stored digital set is multiplied by a fixed digital IF frequency in order to baseband convert the selected channel. In this case the FF-S signal is fixed.

The first option is characterized by faster scan but a larger buffer is needed specially in case multiple set have to be stored for averaging processes. According to the hardware option actually implemented, immediately after the UE switches on, the firmware starts a frequency scan and writes the intermediate results into the Spectral Table. Once a final frequency is selected the microprocessor completes the demodulation and correlates the acquired signal with the SYNCs permanently stored in the UE in order to detect the target SYNC, the relative code group, the midamble, etc. Once a target cell is selected the processor performs the frequency error correction of the UE's reference oscillator (not shown in the Figure), which has to have a stability better than about 10 ppm. The error of the reference oscillator is due both to the temperature shift and to an initial fixed error. The requested stability can be reached for example using as a reference oscillator a TCXO (Temperature Compensated Crystal Oscillator). A generic commercial TCXO can have a stability in temperature of about +/−2.5 ppm in the temperature range from −30 to +75° C. and a fixed error of about +/−2 ppm. The frequency error correction could require frequency variations of two hundred Hz only. The way for obtaining frequency steps spanning from the order of MHz until a few hundred Hz in the whole assigned PLMN band is known from the art of the Frequency Synthesizing Networks based on PLLs (Phase Locked Loop) in nested multi-loop configurations. In this optics both the RF and IF local oscillators are phase-locked to the reference oscillator and all the UE's oscillators belong to a Frequency Synthesizing Network which receives from the microprocessor the control signals RF-S and FF-S and translates them into suitable frequency steps. Because of all the oscillators in the UE are locked to the reference oscillator the overall error introduced by the oscillators has to respect the error limit indicated before and take advantage of the calibration (described later).

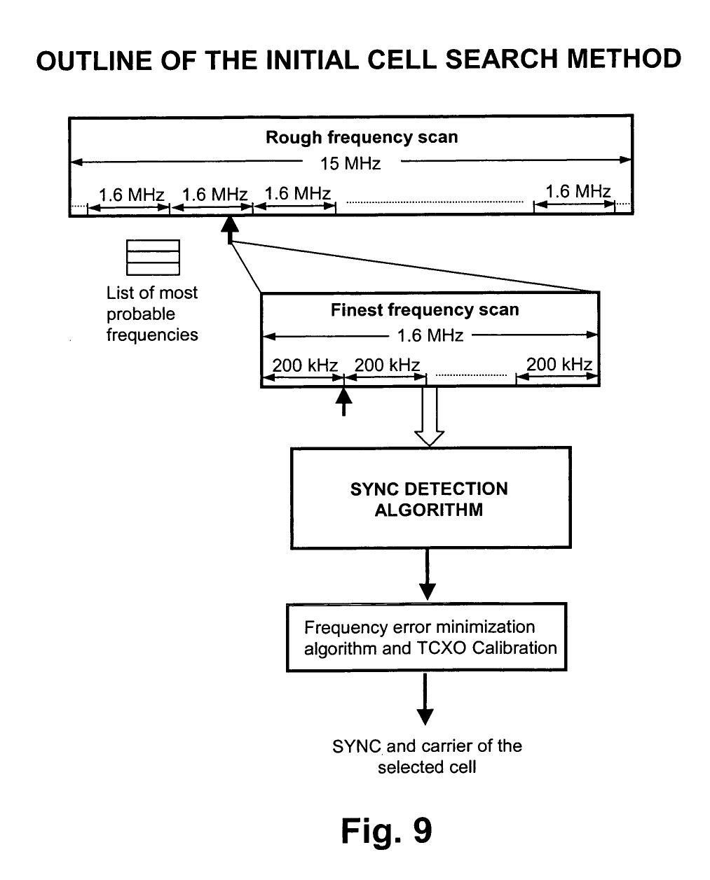

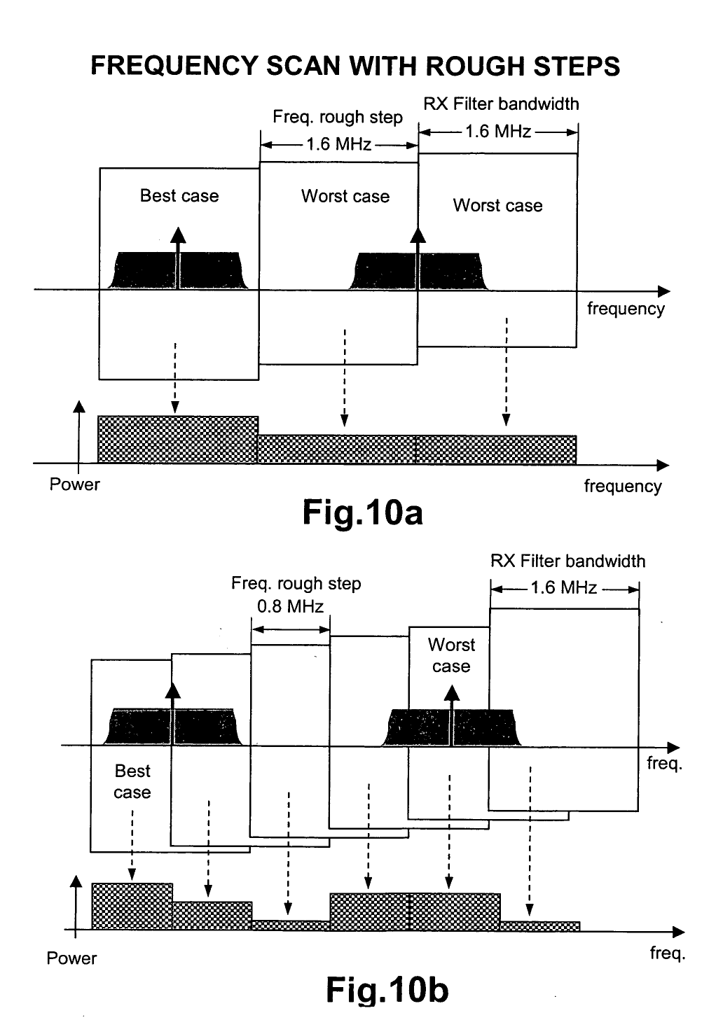

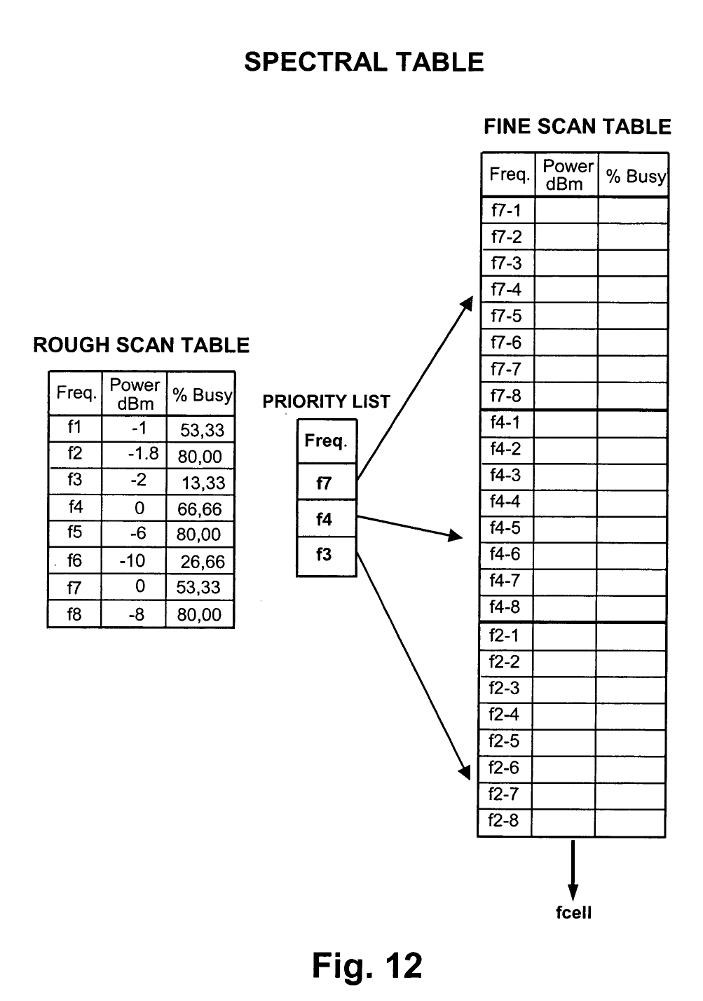

With reference to the FIG. 9 the initial cell search method consists of the following steps:
STEP 1 A set of about 5 ms of data is acquired. The data at the UE antenna is the sum of several signals representing a certain number of different TD-SCDMA frames working on (modulating) different carrier frequencies. The channel band of each modulated carrier frequency is 1.6 MHz wide. TABLE 4A indicates all the possible TD-SCDMA bands. The same table indicates in the right column titled Freq(RFN) the modality of occupation of the various bands. From the specifications it results that the nominal channel spacing is 1.6 MHz and the channel raster is 200 kHz, which means that the carrier frequency must be a multiple of 200 kHz.
STEP 2 A rough search in the band of interest is made. The frequency step of search of 1.6 MHz is chosen, but can also be a fraction of it, and the channel filter is 1.6 MHz. For each frequency, the data power is evaluated with a procedure of power calculation (described below). The Spectral Table of FIG. 12 contains the spectral power of an analyzed PLMN band. From the Spectral Table a subset of “more probable frequencies” is selected for the further refinement. “More probable frequencies” are defined as the frequencies associated to maximum powers in the table. The number of more probable frequencies has been set to 3. With a band of 15 MHz the number of iterations is 8 (or 9 depending on the frequency at which the scanning procedure starts) (TABLE 1B).
STEP 3 A second round of search is made around the “more probable frequencies” found at the previous step. The same procedure for power calculation is used. The step is 200 kHz and the channel filter is always 1.6 MHz. The Spectral Table is updated. The number of iterations is 4×2×3 and the total number of iterations up to now is 32 (TABLE 1 B). The outcome of the second round of search is a candidate frequency. The two scans act as an analysis window large 1.6 MHz (as the channel band) moving step-by-step on the overall RF spectrum, at first, and then in a narrower area for measuring the spectral power which fall inside the window. The absolute maximum power is measured in case the window is perfectly superimposed to the whole spectrum of a channel (see FIG. 10a). The double scan mechanism carried out on the channel raster is able to detect the target frequency with less searching steps than the whole frequencies of the raster.
STEP 4 The target cell is selected by means of a “SYNC detection algorithm” based on the result of the previous frequency scan. Once the SYNC is detected it points to the BCH channel on TS0, to the midambles, scrambling code group, and all relevant information about the target cell.
STEP 5 Frequency error of the reference oscillator internal the UE is corrected, because an error as large as about 20 kHz is expected in the value of the target frequency determined at the end of the double scan. This frequency offset, if not corrected, would lead to a great performance loss both in downlink reception and in uplink transmission. The downlink problem arises in bad decoding process of the information bursts. The calibration of the reference oscillator is a basic procedure included in the synchronization procedure performed after switch on. With the returning information of the SYNC code, the target frequency can be best approached.

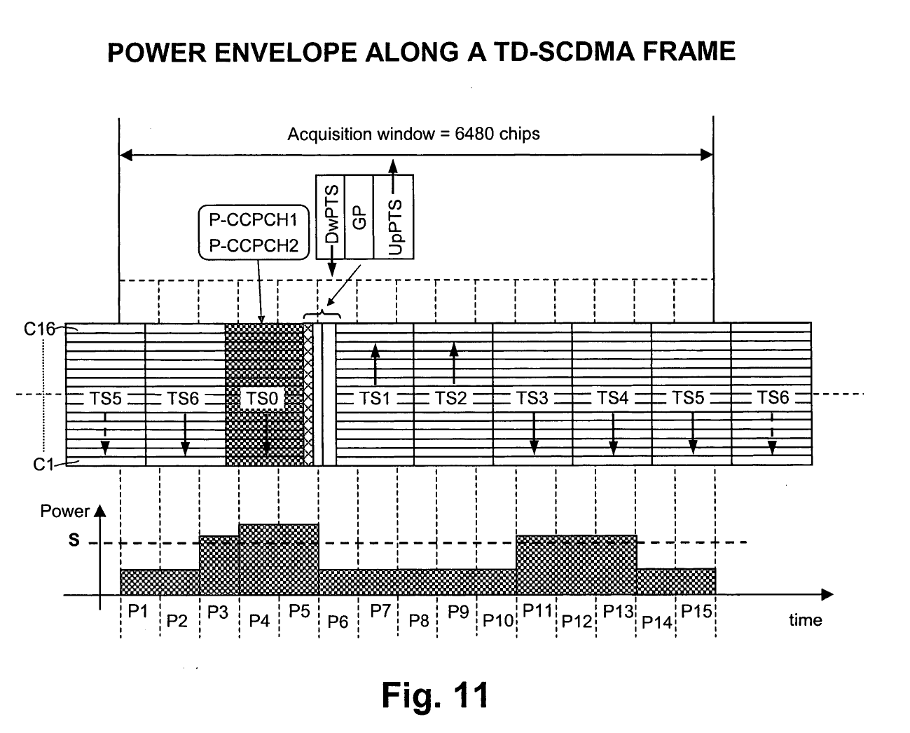

The preceding steps are now better detailed in the following:
STEP 1 A set of 6400+80=6480 chips is acquired; 80 chips more than the length of a frame in order to subdivide the acquired set into an integer number of blocks large as half timeslot, simplifying the power calculation consequently.
STEP 2 In TABLE 1B there is a comparison of the total number of iterations performed in case of a rough frequency step equal to 1.6 MHz and 0.8 MHz for both 15 and 20 MHz band of analysis. The rough frequency steps are selected in order to coincide with raster frequencies. With reference to the FIGS. 10a and 10b the two rough frequency steps have been compared assuming ideal reception. From the comparison it can be noticed that in the worst case the power found with a rough step of 0.8 MHz is about ¾ of the ideal signal power against about ½ in the case of a rough step of 1.6 MHz, but the number of 0.8 MHz steps is twice. With reference to the FIG. 11 the procedure of power calculation used both for rough and fine scan is considered. The acquired set of data is divided into 15 blocks of 432 sequenced chips, like half TD-SCDMA time slot. In each block of a current frequency fᵢ the power P(fᵢ) of the collected data is calculated from the following expression:

$$P ( {f}_{i} ) = {\sum }_{k = 1}^{Bw} {VI}_{k}^{2} + {VQ}_{k}^{2} ,$$

where Bw is the block window of 432 chips, VIₖ and VQₖ are the effective values of the In-phase and In-quadrature baseband components of the k-th chip. At the current searching frequency fᵢ the power of the strongest block is assigned. As will be pointed out later on speaking about simulations, a bad radio propagation may unfavorably conclude the frequency rough scan, so that a frequency of work of the BTS is not found and the finer scan is useless at this point. To state that a frequency is not found means that the power of the strongest block is comparable to the noise threshold for the considered frame. In such a cases averaging on more frames could improve the results. The average can be performed in two way:
a first way is that of executing N times the rough scan, one frame at a time, and take the mean of the results;
a second way is that to acquire N consecutive frames, sum up at every new frame the power of corresponding blocks and take the average on the N frames.
   Despite of the averaging process, a residual probability to not find the frequency of work in the range specified for the operator after a certain number of attempts still exists. In this case an addtional opportunity is that the microprocessor start to scan in the other ranges of frequencies in which the UE can make roaming.

Considering now a scenario in which adjacent cells exert poor interference, the envelope of the power distribution along a frame really reflects the load of the various timeslots and their downlink/uplink destination (down/up arrows in FIG. 11). In this case the power measurements can be used to give an indication of the load of the frequency analyzed. The assumption is that blocks with equal power have equal load. The procedure consists in the following steps:
store the power values P₁ of the 15 blocks of an acquisition window;
select the maximum value Pₘₐₓ;
select a threshold S, for example ¾ Pₘₐₓ;
increment a counter n every time P₁>S×Pₘₐₓ; in that n is indicative of haw many blocks have almost the same power of Pₘₐₓ, to say the same load of Pₘₐₓ;
calculate a percentage of Time Slots with a full load in a frame according to the following formula:

$$\% Busy = \frac{n \times Bw \times 100}{864 \times 7.5}$$

the value 7.5 comes up from the ratio of the acquisition window (6480 chips) and the length of a Time Slot (864 chips). The frame load indicator % Busy takes the value of 40% in the case depicted in FIG. 11. This indicator may be evaluated for K (K≧1) strongest frequencies and put in the Spectral Table nearby the power of the strongest block. The frequency load indicator so obtained could be not reliable in two situations:
first, when the Signal to Noise Ratio (SNR) is low (for example≦0) a frequency with low load may seem fully load due to the noise;
second, in channel rapidly variable like vehicular (speed 120 Km/h or 250 Km/h) a frame with full load may seem little loaded because of an hole of fading.
   In both cases averaging on more frames makes the indicator % Busy more reliable.
   With reference to the FIG. 12 it can be noticed that the Spectral Table consists of two tables: a first one for rough scan and the second one for fine scan. For the sake of simplicity, in the figure possible numerical values of Pmax and % Busy are indicated for the only Rough Scan Table, in which eight frequencies are listed. Once this table is completed the selection criterion which assigns higher priorities to the frequencies with stronger blocks forces the selection of the frequencies f7, f4, and f2 in decreasing order of priority. An insight in the effective advantages offered by this choice casts doubt about f2 and involves the frequency load indicator into the decision. Frequencies f2 and f3 differs of 0,2 dB only but while f2 is busy, f3 is unloaded. In this case the selection of f3 is preferable and its priority increased consequently over f2.
STEP 3 The power calculation procedure for the second round search is the same as the first scan. The fine frequency steps are selected in order to coincide with raster frequencies. At the end of this step the Spectral Table is completed and the selection of a candidate frequency fcell is performed among the ones entering the Fine Scan Table.
STEP 4 An error of about 10 ppm is assumed to be acceptable by the “SYNC detection algorithm”. The position of the DwPTS is determined through the analysis of the correlation between the received signal and the 32 SYNC codes. Due to interference, AWGN (Additive White Gaussian Noise) and channel fading, it's necessary to average the analysis over a certain number of frame. The performance of the algorithms improves if a large number of frames is observed in the averaging window, but the duration of the procedure obviously increases. The key-role in terms of computational complexity is played by the fact that the position of the DwPTS is unknown, so the MS is forced to compute the correlation over the whole frame length. Two known opportunities are open: correlation with FIR filters (Finite Impulse Response), and correlation with FFT (Fast Fourier Transform). The second one is preferred because less complex. Considering at first the correlation with FIR filter, if the complex symbols of the SYNC code are indicated by s₁(i=1, . . . , 64) the coefficients of the FIR filter results

$${a}_{i} = {s}_{64 - i}^{*} ( i = 1 , … , 64 ) ,$$

where * is the conjugate symbol. There will be 32 different SYNCₖ sequences, (k=1, . . . , 32) and as many aₖ matched filters. The 32 correlations c₁, . . . ,C₃₂ are:

$${c}_{k} = {\sum }_{n = 1}^{6400} {\sum }_{i = 1}^{64} r ( n - i ) {a}_{k , i} , ( k = 1 , … , 32 )$$

where r(n) is the received burst. The peak analysis has to be performed over the modulo of each correlation signal cₖ, so it's necessary to get the squared value cₖ² for every 6400 values of the 32 correlation signals. The strongest peak

$${c}_{k}^{2} , ( k = 1 , … , 32 )$$

will point to: the position of the DwPTS in the frame and the BCH TS0 consequently, the code of the selected SYNC out of 32, the corresponding cell code group, the basic midamble. Correlation with matched filters involves a lot multiplications and a long initial delay. The correlation with FFT is now considered. As well known the correlation between two complex signals can be obtained through the Fourier transform ℑ(·). If a(t) and r(t) are two complex signals having the previous meaning, their correlation signal c(r) can be obtained as follows:
a(t)≡s*(−t)
A(f)=ℑ[a(t)]
R(f)=ℑ[r(t)]
c(r)=ℑ⁻¹[A(f)R(f)]
The same operation can be applied to time discrete signals I, Q using DFT (Discrete Fourier Transform) algorithms. If the number of samples per signal is a power of two (N=2^{k}) the computational requirements to obtain the Fourier transformate of the signal is greatly reduced using an FFT algorithm and the resulting number of complex multiplications is

$$\frac{N}{2} {log}_{2} \frac{N}{2} .$$

The following Table gives

| | | | | | |
|---|---|---|---|---|---|
| N | 64 | 128 | 256 | 512 | 1024 |
| $\frac{N}{2} {log}_{2} \frac{N}{2}$ | 16 | 384 | 896 | 2048 | 4608 |

In the synchronization algorithm the signal to be analyzed is made of 6464 complex samples (one frame plus 64 samples needed to get the right correlation if the DwPTS is located at the end of the received burst). One good compromise is to set N to 512 leading to 15 windows over the frame. Detail of DFT is known. The peak analysis is performed as in the preceding case. The number of multiplications can be reduced by means of additional complexity reduction steps.
STEP 5 The target is to set the frequency of work of the UE with the accuracy at least of 0.1 ppm in respect to the frequency of work of the BTS. For this evaluation 3GPP specifications for Narrowband TDD option are taken in account, this can be done because from the radio access point of view concerning the present invention there are no difference between the UTRA Narrowband TDD and the TD-SCDMA. The 3GPP specification foreseen that:
   For the UE: The UE modulated carrier frequency shall be accurate to within +0.1 ppm observed over a period of one timeslot compared to carrier frequency received from the BS (Base Station). These signals will have an apparent error due to BS frequency error and Doppler shift. In the later case, signals from the BS must be averaged over sufficient time that errors due to noise or interference are allowed for within the above ±0.1 ppm figure. The UE shall use the same frequency source for both RF frequency generation and the chip clock.
   For the BS: the modulated carrier frequency of the BS shall be accurate to within ±0.05 ppm observed over a period of one timeslot for RF frequency generation.

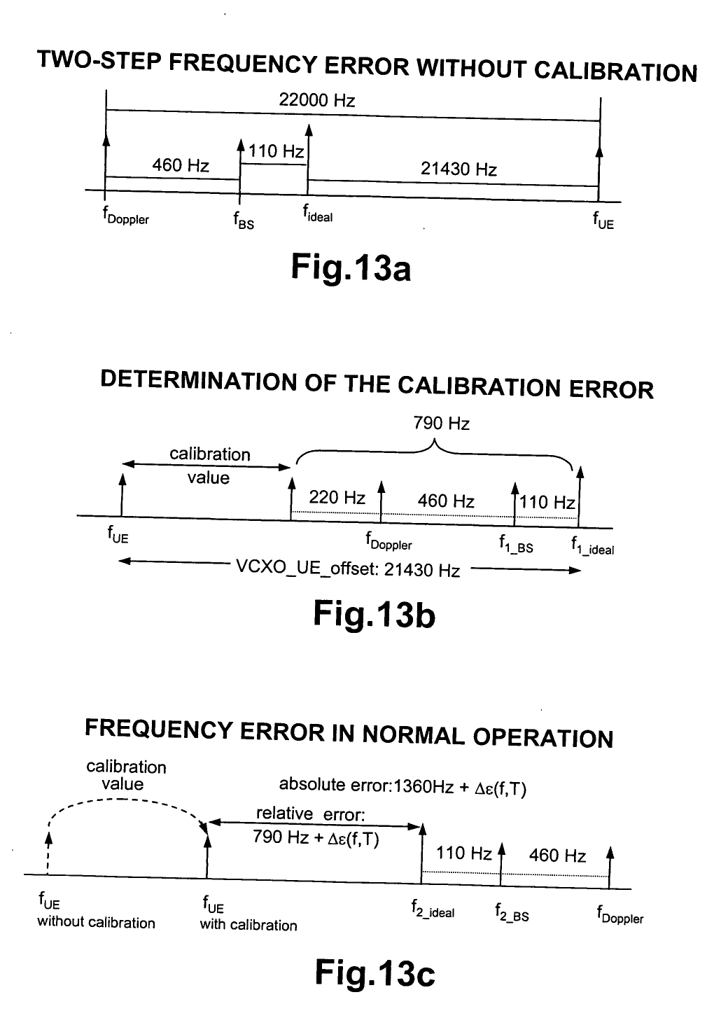

The error committed by the two-step frequency scan is mainly related to the error of the reference oscillator of the UE, because the frequency error of the transmitted carriers is already kept in the limit of the specifications by the BS. It is necessary to distinguish between the first time the UE connects a BS and the normal operation, because normal operation can take advantage of stored calibration values determined first. It's needed to determine the worst case frequency error, and then the restraints on the frequency deviation of the UE's reference oscillator. As far as the deviation concerns the BS, is allowed, in the worst case, to have an error of ±110 Hz from the ideal centre frequency (2.2 GHz upper frequency); an additional error can occur due to the Doppler shift, that for a UE moving at 250 km/h is about 460 Hz. Assuming that an error of about 10 ppm is acceptable by the successive “SYNC detection algorithm”, this corresponds to 22,000 Hz. FIG. 13a depicts the worst case deviation of the UE's oscillator which happens when both the Doppler shift and the +110 Hz error are concurrent (are at the same side in respect of the ideal frequency f_{ideal} of the BS). With reference to the FIG. 13a f_{BS} is the frequency of the BS's oscillator affected by −110 Hz error; f_{Doppler} is the frequency of the BS's oscillator further affected by 460 Hz Doppler shift; f_{UE} is the frequency of the UE's oscillator. In the worst case the maximum deviation allowed to the f_{UE} is: 22000−110−460=21430 Hz, corresponding to ±9.7 ppm. This requirement can be reached from the TCXO of the UE.

In order to reach the precision of ±0.1 ppm (±220 Hz) in respect to the frequency of the BS, the frequency error of the UE is corrected by means of suitable “data aided” techniques exploiting the knowledge of the training sequence in the received signal. The starting point is that the frame alignment has been already reached at the end of STEP 4 with a precision of ½ chip. Two frequency correction opportunities are disclosed, both use the RF-S and/or FF-S control signals in order to vary the local oscillator frequency with the desiderated values. A first opportunity is offered by the following iterative approach:
scan a radiofrequency interval centred around the final carrier fcell selected at STEP 3 and large as the maximum frequency deviation of the UE's reference oscillator, with third frequency steps large at most 1 tenth of said interval, for acquiring in the channel band of the scanned frequency third baseband digital set long at least one frame duration;
for each third frequency step correlate the target SYNC detected at STEP 4 with the third baseband digital set and store positions and amplitudes of new maximum correlation peaks;
select the frequency giving the absolute maximum peak;
scan a radiofrequency interval centered around the frequency previously selected and large as a third frequency step, with fourth frequency steps large at most the needed precision for acquiring in the channel band of the scanned frequency fourth baseband digital set long at least one frame duration;
for each fourth frequency step correlate the SYNC detected at STEP 4 with the fourth baseband digital set and store positions and amplitudes of the maximum correlation peaks;
select an ultimate frequency giving the absolute maximum peak;
store the RF-S and/or FF-S control signals for calibrating the UE's reference oscillator at the successive connections.

The second opportunity to reduce the frequency error is offered by an open loop method presupposing the frame alignment and a frequency deviation as large as 10 ppm. The frequency offset estimation Δ\hat{f} due to the error makes use of a relation proposed in the article: “Carrier Frequency Recovery in All-Digital Modem for Burst-Mode Transmissions”, Authors: M. Luise, R. Reggiani, published on IEEE Transactions On Communications, Vol. 43, No. 2/3/4 February 1995. With reference to the article let r(t) be the received SYNC code N=64 chips long, the estimation of the frequency correction is:

$$Δ \hat{f} = \frac{1}{π {T}_{c} ( M + 1 )} arg [ {\sum }_{k = 1}^{M} R ( k ) ] ,$$

where k is the k^{th} chip of r(t); M is an integer whose optimum value is approximately N/2, for N>>1; and

$$R ( k ) = \frac{1}{N - k} {\sum }_{k = 1}^{N - 1} {y}_{i} {y}_{i - k}^{*}$$

1≦k≦N−1;

$${y}_{i} = {r}_{i - Δ} {a}_{i}^{*} ,$$

1≦i≦N; Δ is the delay (in chips) that aligns the received data with the training sequence, and the

$${a}_{i} ( {a}_{i} {a}_{i}^{*} = 1 )$$

are the training symbols of the SYNC code. The accuracy in an open loop configuration is improved averaging the estimated value Δ\hat{f} over many frames. The value Δ\hat{f} found in this way is used to correct the UE's reference oscillator, besides it is stored for successive connections.

Once the frequency of the UE's reference oscillator is known with the desired precision (0.1 ppm), the offset value between the ideal value f_{ideal} in the lookup table (SIM card) and the value set to the TCXO constitutes a calibration value stored in a non-volatile memory. It represents a correction value for the subsequent synchronization procedures. The calibration value can have three errors in respect to the ideal frequency stored up: the previous error of the BS (max. 110 Hz), a possible error due to the Doppler correction (max. 460 Hz), and the precision of the UE (max. 220 Hz). The worst case happens when the three errors are concurrent and sum up each other to get the value of 790 Hz, as shown in FIG. 13b. The calibration value can be updated every time a frequency is locked, avoiding in this way the problem of the ageing of the oscillator.

The next time the UE will search a frequency the worst case can occur when both the new BS frequency error and the Doppler shift have opposite sign in respect to the previous situation, as depicted in FIG. 13c. The absolute error in this case is the sum of the errors of the previous synchronization (790 Hz) and those of the present situation, i.e.: absolute error=1360+Δε. In the formula Δε represents the error related to the temperature and frequency change.

The two-step frequency scan for the initial cell search method of the invention has been tested by computer simulations. The propagation conditions considered in the simulations are:
noise;
path loss;
multipath with Doppler Effect.

The noise is an Additive White Gaussian Noise (AWGN) with a power that change according to the SNR at the output of the RX filters in the UE, being the SNR set in the simulation. The path loss are added in a multi BTS scenario and are scaled to the path loss of the nearest BTS to the UE which is 0 dB. The rapid variations of the signal due to the multipath and Doppler effect are simulated with a discrete Wide Sense Stationary Uncorrelated Scattering (WSSUS) model. In this model the received signal is represented by the sum of the delayed replicas of the input signal weighted by independent zero-mean complex Gaussian time variant process. The multipath fading environments considered and the relative values used in the simulations are reported in TABLE 1C according to TR 101 112. The simulated frames always contain the BCH channel in timeslot TS0 (FIG. 11) with maximum power and the DwPTS pilot with equal power. In the other timeslots TSs, according to the simulation tasks, there are random data and midamble for the TSs busy or zeros for empty TSs. The frames is QPSK modulated on a carrier and filtered with an RRC filter like the RX filters shown in FIG. 7. The simulation assumptions are reported in TABLE 2C in which for the BTS and the UE frequency error worst case values have been chosen. The simulations are performed with a single BTS, firstly, and then with two BTSs. In the first case the BTS works on a single carrier in different environments and with different SNR. The simulation results are grouped in TABLE 3C, 4C, and 5C. The following parameters are evaluated:
Pe=probability of doesn't found the BTS's frequency of work;
Pe_{—}5=Probability of error averaging on five consecutive frames;
Pe_{—}9=Probability of error averaging on nine consecutive frames.

The results obtained for the single BTS suggest some comments about: Frame-Load, Environment IndoorNehicular, Depth of the Average; Sampling rate.
Frame-Load: the worst case is when the BS send a frame with low load, for example only the BCH and the DwPTS channels are transmitted at full power. The best case is when the whole frame is at full power.
Environment: with low frame-load the channels indoor and vehicular have quite the same performances. With high frame-load there are always improvements in the simulation results. In particular the improvements becomes significant as the MS speed increases, because zones affected by deep fading are crossed quickly.
Average: averaging the results on several frames the performance of the frequency scan procedure improves and in the vehicular ambient a velocity of 120 Km/h is sufficient to reduce almost at zero the probability of error, even at negative SNR. The simulations indicate a little improvement in the results using a rough frequency step of 0.8 MHz instead of 1.6 MHz especially in the vehicular ambient where the Doppler spectrum isn't flat.
Sampling Rate: reducing the Sampling Rate from 16/Tc to 8/Tc there are not relevant worsening of the frequency scan; this is true both in the vehicular and in the indoor ambient even if only the results of the vehicular case at 120 Km/h has been reported in TABLE 4C.

Considering now a Multi BTS scenario, the presence of two BTSs is simulated. Each BTS works on a single frequency (F₁ for BTS, and F₂ for BTS₂). The following parameters are evaluated:
P1=probability of found F₁ as the strongest frequency;
Pe1=1-P1=probability of doesn't chose F₁ as the strongest frequency;
P2=probability of found F₂ as the strongest frequency;
Pe2=1-P2=probability of doesn't chose F₂ as the strongest frequency;
Ptot=probability of found F₁ or F₂;
Pe=1-Ptot=probability of doesn't found neither F₁ nor F₂.

In TABLE 6C and 7C the simulation for indoor and vehicular channel respectively are summarized. The results obtained suggest that with two BTSs the probability of doesn't found at least a workable frequency decrease respect to the case of one BTS with one frequency of work.

TABLE 1A
FREQUENCY BANDS OF GSM-GPRS (TDMA-FDD)

| SYSTEM | FBN | MS → BTS | BTS → MS | RFN |
|---|---|---|---|---|
| P-GSM 900 | 0000 | 890-915 | 935-960 | 131 ≦ RFN ≦ 255 |
| E-GSM 900 | 0001 | 880-915 | 925-960 | 81 ≦ RFN ≦ 255 |
| R-GSM 900 | 0010 | 876-915 | 921-960 | 61 ≦ RFN ≦ 255 |
| DCS 1800 part | 0011 | 1710-1785 | 1805-1880 | 1 ≦ RFN ≦ 255 |
| a | | | | |
| DCS 1800 part | 0100 | 1710-1785 | 1805-1880 | 0 ≦ RFN ≦ 118 |
| b | | | | |
| PCS 1900 part | 0101 | 1850-1910 | 1930-1990 | 1 ≦ RFN ≦ 255 |
| a | | | | |
| PCS 1900 part | 0110 | 1850-1910 | 1930-1990 | 0 ≦ RFN ≦ 43 |
| b | | | | |

The carrier spacing is 200 kHz.
FBN = Frequency Band Number;
RFN = Radio Frequency Number.
Part a and part b band splitting allows the use of 1 byte only for RFN description.

TABLE 2A
FREQUENCY BANDS OF
3GPP UTRA-FDD (W-CDMA 3.84 Mcps)

| TX-RX frequency | | |
|---|---|---|
| separation | UE → node B | node B → UE |
| 190 MHz | 1920-1980 | 2110-2170 |
| 80 MHz | 1850-1910 | 1930-1990 |

The carrier spacing is 5 MHz, while the carrier raster is 200 kHz.

TABLE 3A
FREQUENCY BANDS OF 3GPP UTRA-TDD
(HCR 3.84 Mcps or LCR 1.28 Mcps)

Frequency Range for Uplink and Downlink transmission
1900-1920 MHz
2010-2025 MHz
1850-1910 MHz
1930-1990 MHz
1910-1930 MHz
The carrier spacing for LCR is 1.6 MHz, for HCR is 5 MHz, while the carrier raster is 200 kHz in both cases.

TABLE 4A
FREQUENCY BANDS OF 3GPP
UTRA-TDD (TD-SCDMA 1.28 Mcps)
AND OCCUPATION OF THE FREQUENCY BANDS

| FBN | BAND | RFN | Freq(RFN) |
|---|---|---|---|
| 0000 | 1785-1805 | 0 ≦ RFN ≦ 92 | 1785.8 + 0.2 × (RFN − 1) |
| 0001 | 1900-1920 | 0 ≦ RFN ≦ 92 | 1900.8 + 0.2 × (RFN − 1) |
| 0010 | 1920-1980 part a | 0 ≦ RFN ≦ 255 | 1920.8 + 0.2 × (RFN − 1) |
| 0011 | 1920-1980 part b | 0 ≦ RFN ≦ 36 | 1971.8 + 0.2 × RFN |
| 0100 | 1980-2010 | 0 ≦ RFN ≦ 142 | 1980.8 + 0.2 × (RFN − 1) |
| 0101 | 2010-2025 | 0 ≦ RFN ≦ 67 | 2010.8 + 0.2 × (RFN − 1) |
| 0110 | 2110-2170 part a | 0 ≦ RFN ≦ 255 | 2110.8 + 0.2 × (RFN − 1) |
| 0111 | 2110-2170 part b | 0 ≦ RFN ≦ 36 | 2161.8 + 0.2 × RFN |
| 1000 | 2170-2220 | 0 ≦ RFN ≦ 242 | 2170.8 + 0.2 × (RFN − 1) |

The carrier spacing is 1.6 MHz, while the carrier raster is 200 kHz.

TABLE 1B
ITERATIONS FOR 2-STEP FREQUENCY SCAN

| | 15 MHz band | | 20 MHz band | |
|---|---|---|---|---|
| Rough freq. step [MHz] | 1.6 | 0.8 | 1.6 | 0.8 |
| Number of frequencies | 8 | 17 | 11 | 23 |
| of rough searching | | | | |
| iterations | | | | |
| Fine frequency step | 0.2 | 0.2 | 0.2 | 0.2 |
| [MHz] | | | | |
| Number of frequencies | 8 | 4 | 8 | 4 |
| of fine searching | | | | |
| iterations | | | | |
| Number of total | 8 + 3 × | 17 + 3 × | 11 + 3 × | 23 + 3 × 4 = |
| iterations with fine | 8 = 32 | 4 = 29 | 8 = 35 | 35 |
| search around the 3 | | | | |
| strongest frequencies | | | | |

TABLE 1C
MULTIPATH FADING DESCRIPTION ACCORDING
TO TR 101 112

| Indoor channel A | | | | | |
|---|---|---|---|---|---|
| (speed 3 Km/h) | | | Vehicular channel A | | |
| | Averag | | (speed 120 Km/h and 250 Km/h) | | |
| Relative | power | Doppler | Relative | Average | Doppler |
| Delay [ns] | [dB] | Spectrum | Delay [ns] | power [dB] | Spectrum |
| 0.0 | 0.0 | flat | 0.0 | 0.0 | classic |
| 50 | −3.0 | flat | 310 | −1.0 | classic |
| 110 | −10.0 | flat | 710 | −9.0 | classic |
| 170 | −18.0 | flat | 1090 | −10.0 | classic |
| 290 | −26.0 | flat | 1730 | −15.0 | classic |
| 310 | −32.0 | flat | 2510 | −20.0 | classic |

TABLE 2C
SIMULATION ASSUMPTIONS

| | |
|---|---|
| Simulator | Matlab |
| Bit Rate | 1.28 Mbps |
| Samples for each chip | 16 |
| misalignment of worst case on chip | ½ Tc (Tc = 0.78125 μs) |
| acquisition length | 6400 + 80 chips |
| block length | 432 chips |
| roll off factor | 0.22 |
| analysed band | 8 MHz |
| IF filter bandwidth | 1.6 MHz |
| rough frequency step | 0.8 MHz |
| fine frequency step | 200 Kz |
| BTS frequency error | 800 Hz |
| UE frequency error | 220 Hz |
| channel model | AWGN + Path Loss + WSSUS |

TABLE 3C
Indoor channel A, mobile speed 3 Km/h

| | | | | | Number |
|---|---|---|---|---|---|
| | | | | | of frames |
| frame load | SNR | Pe [%] | Pe_5 [%} | Pe_9 [%] | simulated |
| only BCCH + | 3 | 3 | 1.3 | 0.6 | 2880 |
| DwPTS | 2 | 4.4 | 2.3 | 1.6 | 2880 |
| | 1 | 5.7 | 3.1 | 2.4 | 2880 |
| | 0 | 8.1 | 5.4 | 3.9 | 2880 |
| | −1 | 11.4 | 7.7 | 5.6 | 2880 |
| full load | 3 | 2 | 0.7 | 0.1 | 2880 |
| | 2 | 3.1 | 1.2 | 0.3 | 2880 |
| | 1 | 4.5 | 1.8 | 1 | 2880 |
| | 0 | 7 | 3.5 | 2.5 | 2880 |
| | −1 | 8.4 | 5.2 | 3.5 | 2880 |

TABLE 4C
Vehicular channel A, mobile speed 120 Km/h, performances vs
Sample Rate (SR)

| | | | | | | Number |
|---|---|---|---|---|---|---|
| | | | | | | of |
| | | | | | | frames |
| frame | | Pe [%] | Pe_5 [%] | Pe [%] | Pe_5 [%] | simu- |
| load | SNR | SR = 16/Tc | | SR = 8/Tc | | lated |
| only | 3 | 4 | 0 | 4.4 | 0.05 | 1920 |
| BCCH + | | | | | | |
| DwPTS | | | | | | |
| | 2 | 5.7 | 0 | 5.7 | 0.25 | 1920 |
| | 1 | 6 | 0.2 | 7 | 0.35 | 1920 |
| | 0 | 8.2 | 1.1 | 8.75 | 1 | 1920 |
| | −1 | 11.75 | 1.6 | 11.55 | 1.6 | 1920 |
| | −2 | 15.2 | 3 | 16.6 | 7 | 1920 |
| full load | 3 | 0.7 | 0 | 0.6 | 0 | 1920 |
| | 2 | 1.3 | 0.05 | 0.85 | 0 | 1920 |
| | 1 | 1.30 | 0.05 | 1.5 | 0 | 1920 |
| | 0 | 1.4 | 0 | 2 | 0 | 1920 |
| | −1 | 2.15 | 0 | 2.35 | 0 | 1920 |
| | −2 | 3.6 | 0 | 2.8 | 0.1 | 1920 |

TABLE 5C
Vehicular channel A, mobile speed 250 Km/h

| | | | | | Number of |
|---|---|---|---|---|---|
| | | | | | frames |
| Frame load | SNR | Pe [%] | Pe_5 [%] | Pe_9 [%] | simulated |
| only BCCH + | 3 | 3.6 | 0 | 0 | 1920 |
| DwPTS | 2 | 3.8 | 0.2 | 0 | 1920 |
| | 1 | 5.2 | 0.2 | 0 | 1920 |
| | 0 | 6 | 0.4 | 0.05 | 1920 |
| | −1 | 9.65 | 0.5 | 0.05 | 1920 |
| | −2 | 13.3 | 1.6 | 0.3 | 1920 |
| full load | 3 | 0.15 | 0 | 0 | 1920 |
| | 2 | 0.2 | 0 | 0 | 1920 |
| | 1 | 0.1 | 0 | 0 | 1920 |
| | 0 | 0.35 | 0 | 0 | 1920 |
| | −1 | 0.9 | 0 | 0 | 1920 |
| | −2 | 1.1 | 0 | 0 | 1920 |

TABLE 6C
Indoor channel A, mobile speed 3 Km/h

| | Relative | SNR | | | | | | | Number of frames |
|---|---|---|---|---|---|---|---|---|---|
| Frame load | attenuation [dB] | [dB] | P1 [%] | Pe1 [%] | P2 [%] | Pe2 [%] | Ptot [%] | Pe [%] | simulated |
| F₁: full load | 0 | 3 | 60.1 | 39.9 | 39.8 | 60.2 | 99.9 | 0.1 | 960 |
| F₂: BCCH + DwPTS | 0 | | | | | | | | |
| F₁: full load | 0 | 1 | 60.83 | 39.17 | 38.24 | 61.77 | 99.06 | 0.94 | 960 |
| F₂: BCCH + DwPTS | 0 | | | | | | | | |
| F₁: full load | 0 | 3 | 78.96 | 21.04 | 20.63 | 79.37 | 99.59 | 0.41 | 960 |
| F₂: full load | −3 | | | | | | | | |
| F₁: BCCH + DwPTS | 0 | 3 | 76.35 | 23.65 | 22.9 | 77.1 | 99.3 | 0.75 | 960 |
| F₂: full load | −3 | | | | | | | | |
| F₁: BCCH + DwPTS | 0 | 1 | 74.8 | 25.2 | 23.4 | 76.6 | 98.2 | 1.8 | 960 |
| F₂: full load | −3 | | | | | | | | |

TABLE 7C
Vehicular channel A, mobile speed 120 Km/h

| | Relative | SNR | | | | | | | Number of frames |
|---|---|---|---|---|---|---|---|---|---|
| Frame load | attenuation [dB] | [dB] | P1 [%] | Pe1 [%] | P2 [%] | Pe2 [%] | Ptot [%] | Pe [%] | simulated |
| F₁: full load | 0 | 1 | 73.6 | 26.4 | 26.1 | 73.9 | 99.7 | 0.3 | 960 |
| F₂: BCCH + DwPTS | 0 | | | | | | | | |
| F₁: BCCH + DwPTS | 0 | 3 | 43.4 | 56.6 | 55.8 | 44.2 | 99.2 | 0.8 | 960 |
| F₂: full load | −3 | | | | | | | | |
| F₁: BCCH + DwPTS | 0 | 1 | 43.2 | 56.8 | 55.5 | 44.5 | 98.7 | 1.3 | 960 |
| F₂: full load | −3 | | | | | | | | |

1. Method for the initial cell search in a cellular telephony network in which radio signals like a plurality of modulated carriers are transmitted in the assigned band from one or more base transceiver stations (BTS1, BTS2) downlink to at least a mobile station (MS1), the transmitted signals being subdivided into frames having predefined duration and the frames being subdivided into a predefined number of timeslots comprising a synchronization timeslot (DWPTS) and a timeslot (TS0) associated to a service channel (P-CCPCH1,2) conveying information relevant to the transmitting cell, both transmitted with maximum or nearly maximum permissible power, and the synchronization timeslot (DwPTS) including a synchronization sequence (SYNC) pointing to the service channel for receiving the identity of the transmitting cell, characterized in that the mobile station (MS) performs at switch-on the steps of:
a) scanning the assigned band with first frequency steps large at most the channel band (1.6 MHz) of said modulated carriers and coinciding with positions of a channel raster known to the mobile station for converting to baseband the channel band of the scanned frequency acquiring in that a first digital set long at least one frame duration;
b) for each first frequency step (1.6 MHz) subdividing the first digital set into sequential blocks of fixed duration, calculating the power of each block and assigning to the scanned frequency a priority corresponding to the power of the strongest block, then selecting at least a scanned frequency having the highest priority;
c) scanning the channel band around the selected frequency/ies, with second frequency steps as large as adjacent positions of the raster (200 kHz), for converting to baseband the channel band of the scanned frequency acquiring in that a second digital set long at least one frame duration;
d) for each second frequency step (200 kHz) subdividing the second digital set into sequential blocks of fixed duration, calculating the power of each block and assigning to the scanned frequency a priority corresponding to the power of the strongest block, then selecting the scanned frequency having the highest priority;
e) selecting among the frequencies selected at steps b) and d) a final frequency having the absolute highest priority;
f) discriminating from the second digital set of the final frequency said synchronization sequence to get the identity of the transmitting cell.

2. Method for the initial cell search in accordance with claim 1, characterized in that at step a):
the whole assigned radiofrequency band is converted to an intermediate frequency IF;
the IF signal is converted from analog to digital and the digital set of the whole assigned band long at least one frame duration is stored (BUFFER);
the stored digital set is scanned multiplying it by a digital intermediate frequency IF varying with the first frequency steps (1.6 MHz), obtaining said first digital set at the output of a baseband filter (RX filter) having the channel band.

3. Method for the initial cell search in accordance with claim 2, characterized in that at step c):
the stored digital set is scanned multiplying it by a digital intermediate frequency IF varying with the second frequency steps (200 kHz) in the channel band around the selected frequency/ies, obtaining said second digital set at the output of said baseband filter (RX filter).

4. Method for the initial cell search in accordance with claim 1, characterized in that at step a):
the channel band of a frequency scanned with the first frequency steps (1.6 MHz) is converted to an intermediate frequency IF;
the IF signal is converted from analog to digital and the digital set long at least one frame duration is stored (BUFFER);
the stored digital set is multiplied by a fixed digital intermediate frequency IF, obtaining said first digital set at the output of a baseband filter (RX filter) having the channel band.

5. Method for the initial cell search in accordance with claim 4, characterized in that at step c):
the channel band of a frequency scanned with the second frequency steps (200 kHz) is converted to an intermediate frequency IF;
the IF signal is converted from analog to digital and the digital set long at least one frame duration is stored (BUFFER);
the stored digital set is multiplied by a fixed digital intermediate frequency IF, obtaining said second digital set at the output of said baseband filter (RX filter).

6. Method for the initial cell search in accordance with claim 1, characterized in that the first frequency steps are large as half the channel band.

7. Method for the initial cell search in accordance with claim 1, characterized in that for at least a subset of the scanned frequencies a frame load indicator (% Busy) is calculated as the percentage of time slots (TS0, . . . , TS6) whose power exceeds a pre-established fraction (S) of the power of the strongest block, the highest frame load indicators reducing the priorities of the selected frequencies having almost equal priorities.

8. Method for the initial cell search in accordance with claim 7 characterized in that said pre-established fraction (S) is 3/4 the power of the strongest block.

9. Method for the initial cell search in accordance with claim 1, characterized in that said digital sets spans multiple frame durations and the power of each sequential block is the average calculated on the multiple blocks.

10. Method for the initial cell search in accordance with claim 1, characterized in that the frames of adjacent base transceiver stations (BTS1, BTS2) are each other synchronized.

11. Method for the initial cell search in accordance with claim 1, characterized in that the duration of each block spans half timeslot.

12. Method for the initial cell search in accordance with claim 1, characterized in that the synchronization sequence (SYNC) transmitted in the synchronization timeslot (DWPTS) is one out of N synchronization sequences associated one-to-one to the cells, and the synchronization sequence (SYNC) of said transmitting cell being discriminated by correlating the second digital set associated to the final frequency with N synchronization sequences stored in the mobile station (MS1) and selecting the one generating the maximum correlation peak.

13. Method for the initial cell search in accordance with claim 1, characterized in that three frequencies of the scan having the highest priorities are selected at step b).

14. Method for the initial cell search in accordance with claim 1, characterized in that the timeslots are shared by code division.

15. Method for the initial cell search in accordance with claim 1, characterized in that the timeslots of a frame are split into two groups, a first one for receiving signals on downlink and a second one for transmitting signals on uplink.

16. A mobile station suitable to be used in a cellular telephony network in which radio signals like a plurality of modulated carriers are transmitted in the assigned band from one or more base transceiver stations (BTS1, BTS2) downlink to at least a mobile station (MS1), the transmitted signals being subdivided into frames having predefined duration and the frames being subdivided into a predefined number of timeslots comprising a synchronization timeslot (DwPTS) and a timeslot (TS0) associated to a service channel (P-CCPCH1,2) conveying information relevant to the transmitting cell, both transmitted with maximum or nearly maximum permissible power, and the synchronization timeslot (DwPTS) including a synchronization sequence (SYNC) pointing to the service channel for discriminating the downlink signals and the identity of the transmitting cell; the mobile station including frequency conversion means (RX filter, RF local oscillator, IF filter, IF local oscillator), analog to digital conversion means (ADC), and a baseband processor (BASEBAND PROCESSOR-RX) connected to a SIM card storing the channel raster of the permitted frequencies inside the assigned band, characterized in that further includes a memory buffer (BUFFER) for storing one or more frame durations of the demodulated data, and a firmware which controls the baseband processor to carry out the steps of the method for the initial cell search of the claim 1.

17. A mobile station in accordance with claim 16 characterized in that:
said frequency conversion means includes a radiofrequency local oscillator (RF local oscillator) and an analog mixer for converting into the band of an analog band-pass intermediate frequency filter (IF filter) the whole assigned radiofrequency band;
said analog to digital conversion means (ADC) are placed downstream said intermediate frequency filter (IF filter) for digital converting the whole assigned band;
said memory buffer (BUFFER) are placed downstream the analog to digital conversion means (ADC) for memorizing the digital set of the whole assigned band.

18. A mobile station in accordance with claim 17, characterized in that:
said frequency conversion means further includes a numerical intermediate frequency oscillator (IF local oscillator) tunable in conformity of either said first or second frequency steps for scanning the stored digital set; and
a digital multiplier for converting in the channel band of a baseband filter (RX filter) the band of the scanned frequency.
